(19) United States
(12) Patent Application Publication
(10) Pub. No.: US 2016/0120725 A1
(43) Pub. Date: May 5, 2016

(54) POSTURAL FACE/HEAD SUPPORT WITH CHIN STRAP

(71) Applicants: Desmond Slattery, Bryn Mawr, PA (US); Bronwen DuPertuis, Philadelphia, PA (US)

(72) Inventors: Desmond Slattery, Bryn Mawr, PA (US); Bronwen DuPertuis, Philadelphia, PA (US)

(21) Appl. No.: 14/931,721

(22) Filed: Nov. 3, 2015

Related U.S. Application Data
(60) Provisional application No. 62/074,389, filed on Nov. 3, 2014.

(51) Int. Cl. A61G 13/12; A61H 37/00

(52) U.S. Cl. CPC A61G 13/121; A61H 37/00

(57) ABSTRACT

A headrest cushion, for supporting the head of a person about the persons face, has an adjustable chin strap to comfortably support the person's chin. A massage or medical treatment table that uses the headrest is also provided.

### CROSS-REFERENCE TO RELATED APPLICATIONS

This application is a non-provisional of and claims the benefit of the priority of U.S. provisional application for patent No. 62/074,389, file on Nov. 3, 2014, which is incorporated herein by reference in its entirety.

### BACKGROUND OF THE INVENTION

1. Field of the Invention

The present invention is directed to a headrest cushion, a headrest, and a massage or medical treatment table using such headrest cushion or headrest.

2. Brief Description of the Prior Art

Examples of massage or medical treatment tables are known in the art. One such example is illustrated in U.S. Pat. No. 8,555,437, issued on Oct. 15, 2013, which is incorporated herein by reference in its entirety. However, none of the known massage or medical treatment tables address the proper positioning and support of the lower jaw of the person receiving treatment on the table. The need persists for a table and/or head/face rest that addresses the proper positioning and support of the lower jaw of the person receiving treatment on the table.

### SUMMARY OF THE INVENTION

This invention provides a headrest cushion, for supporting the head of a person about the persons face, that has an adjustable chin strap to comfortably support the person's chin. A massage or medical treatment table that uses the headrest is also provided.

This invention accomplishes the goal of creating optimal posture of the head and cervical spine when lying face down on a massage/treatment/medical table. The pillow supports the forehead and cheeks and the chin strap encourages the jaw to gently retract and rest in a neutral position. The chin strap is easily adjustable to each individual. This positioning also reduces sinus pressure and may help to alleviate symptoms of temporomandibular joint syndrome, also known as TMJ.

This Face/Head support utilizes a traditional face rest with support frame and foam pillow. The invention includes the addition of a chin support strap. The strap loops through two channels on the outer edges of the vinyl upholstery. The Chin strap is adjustable to best suit each individual and is secured with hook-and-loop fasteners to the support frame of the headrest.

It is an aspect of the present invention to provide a headrest assembly for supporting the face of a receiving treatment using a massage or medical treatment table, wherein the headrest comprises:
a headrest frame that couples with the massage/medical treatment table;
a foam pillow covered in vinyl material that attaches to the frame of the headrest and has an opening that conforms to the face of the user; and
an adjustable, vinyl chin strap that loops through two channels sewn into the vinyl covering.
   The chin strap is secured to the support frame of the headrest with hook-and-loop fasteners after being properly adjusted for the user.

It is another aspect of the present invention to provide a massage or medical table, for providing treatment or therapy to a person, comprising:
a body supporting portion comprising:
   a table frame; and
   at least one body supporting cushion adapted for supporting at least a portion of the person's body other than the person's head, the table frame being adapted for supporting the body supporting cushion at a height above a floor;
a headrest; and
attachment means for attaching the headrest to the body supporting portion, wherein the headrest comprises:
a headrest frame;
a headrest cushion including a top portion adapted to support a portion of the person's head at or near the person's forehead or supraorbital ridge, a left portion adapted to support a left portion of the person's face, and a right portion adapted to support a right portion of the person's face, the left and right portions of the headrest cushion being attached at one end to opposite ends of the top portion of the headrest cushion, each of the left and right portions of the headrest cushion having a distal end located distally from the top portion of the headrest cushion, there being a gap between the distal ends of the left and right portions of the headrest cushion, and the distal ends being adapted to be positioned proximate the person's chin, the headrest cushion having a front that faces toward the person's face and a back that faces away from the person's face, each of the left portion, the top portion, and the right portion of the headrest cushion having a front and a back, the front of the headrest cushion comprising the front of the left portion, the front of the top portion, and the front of the right portion, the back of the headrest cushion comprising the back of the left portion, the back of the top portion, and the back of the right portion; and
a chin strap positioned to extend across the gap and over the left and right portions of the headrest cushion on the front of the headrest cushion proximate the distal ends of the left and right portions of the headrest cushion, the chin strap extending through a left channel and a right channel and being secured to the headrest by chin strap fastening means.

It is yet another aspect of the present invention to provide a massage or medical table in accordance with any previously described, wherein the chin strap fastening means comprises:
a left fastening means and a right fastening means, wherein the left fastening means secures the chin strap to the headrest frame proximate the left headrest cushion portion, wherein the right fastening means secures the chin strap to the headrest frame proximate the right headrest cushion portion, and wherein the left fastening means and the right fastening means are adapted to allow the length of the chin strap extending between the left channel and the right channel to be adjusted.

It is a further aspect of the present invention to provide a massage or medical table in accordance with any previously described, wherein the left fastening means includes a first fastener portion and a second fastener portion, wherein the right fastening means includes a first fastener portion and a second fastener portion, wherein the first fastener portion of the left fastening means is attached to the chin strap, wherein the second fastener portion of the left fastening means is attached to the headrest frame, wherein the first fastener portion of the right fastening means is attached to the chin strap, and wherein the second fastener portion of the right fastening means is attached to the headrest frame.

It is a further aspect of the present invention to provide a massage or medical table in accordance with any previously described, wherein the left fastening means is a first hook and loop fastener system, wherein the right fastening means is a second hook and loop fastener system, wherein the first fastener portion of the left fastening means is selected from a hook portion and a loop portion of the first hook and loop fastener system, wherein the second fastener portion of the left fastening means is selected from a hook portion and a loop portion of the first hook and loop fastener system and to be complementary to the first fastener portion of the left fastening means, wherein the first fastener portion of the right fastening means is selected from a hook portion and a loop portion of the second hook and loop fastener system, wherein the second fastener portion of the right fastening means is selected from a hook portion and a loop portion of the second hook and loop fastener system and to be complementary to the first fastener portion of the right fastening means.

It is a further aspect of the present invention to provide a massage or medical table in accordance with any previously described, wherein the chin strap includes a middle portion, a left portion, and a right portion, wherein each of the middle portion, the left portion, and the right portion of the chin strap has a length, wherein the first fastener portion of the left fastening means extends along at least a portion of the length of the left portion of the chin strap such that the chin strap can be attached to the headrest frame at a user selected one of a plurality of positions along the length of the left portion of the chin strap, and wherein the first fastener portion of the right fastening means extends along at least a portion of the length of the right portion of the chin strap such that the chin strap can be attached to the headrest frame at a user selected one of a plurality of positions along the length of the right portion of the chin strap.

It is a further aspect of the present invention to provide a massage or medical table in accordance with any previously described, wherein the headrest frame comprises:
a support plate having a back side and a front side, the support plate supporting the headrest cushion and resembling the headrest cushion in planform, the support plate having a top portion, left portion and a right portion, the left and right portions of the support plate being attached at one end to opposite ends of the top portion of the support plate, each of the left and right portions of the support plate having a distal end located distally from the top portion of the support plate, there being a gap between the distal ends of the left and right portions of the support plate, and the distal ends of the left and right portions of the support plate being adapted to be positioned proximate the person's chin, each of the left portion, the top portion, and the right portion of the support plate having a front side and a back side, the front side of the support plate comprising the front side of the left portion of the support plate, the front side of the top portion of the support plate, and the front side of the right portion of the support plate, the back side of the support plate comprising the back side of the left portion of the support plate, the back side of the top portion of the support plate, and the back side of the right portion of the support plate;
first and second attachment plates each projecting perpendicularly from the back side of the support plate, the first and second attachment plates being parallel to each other, the first and second attachment plates being spaced apart from each other, the first and second attachment plates being in registry with each other, the first and second attachment plates each having a first end and a second end;
a pair of elongated members each having first and second ends, each of the pair of elongated members being parallel to each other;
an elongated shaft extending between the second ends of the pair of elongated members, the elongated shaft having a longitudinal axis;
a first pair of linking members each having first and second ends, the second end of each of the first pair of linking members being pivotally connected to the second end of a respective one of the first and second attachment plates, the first end of each of the first pair of linking members being at least pivotally connected to the second end of a respective one of the pair of elongated members, each of the first pair of linking members being selectively pivotally movable relative to the second end of the respective one of the pair of elongated members about a pivot axis coincident with the longitudinal axis of the elongated shaft; and
a second pair of linking members each having first and second ends, each of the second pair of linking members having an elongated slot extending along a portion thereof proximate its second end, the elongated shaft extending through the elongated slot of each of the second pair of linking members, the first end of each of the second pair of linking members being pivotally connected to the first end of a respective one of the first and second attachment plates,
wherein the support plate has a position and a tilt angle relative to the body supporting portion and wherein the first pair of linking members and the second pair of linking members allow adjustment of the position and the tilt angle to suit the person receiving treatment.

It is a further aspect of the present invention to provide a massage or medical table in accordance with any previously described, further comprising:
a pair of grommets supported by the body supporting portion at one end thereof, each of the pair of grommets having a flange adapted for attachment to the body supporting portion, each of the pair of grommets having a sleeve adapted for receiving a portion of a respective one of the pair of elongated members to thereby mount the headrest to the body supporting portion.

It is a further aspect of the present invention to provide a massage or medical table in accordance with any previously described, further comprising:
a locking lever operably linked to the elongated shaft and being pivotally movable between a first position and a second position, wherein the support plate is locked in position relative to the body supporting portion when the locking lever is in the first position, and wherein the support plate is released for movement to adjust its position and tilt angle relative to the body supporting portion when the locking lever is in the second position.

It is a further aspect of the present invention to provide a massage or medical table in accordance with any previously described, wherein the headrest further comprises:
headrest cushion fastening means for attaching the headrest cushion to the support plate.

It is a further aspect of the present invention to provide a massage or medical table in accordance with any previously described, wherein the headrest cushion fastening means comprises:
a plurality of headrest cushion fastening systems each having a first portion for attachment to the front side of the support plate and a second portion for attachment to the back of the headrest cushion, the first portion of each of the plurality of headrest cushion fastening systems engaging the second portion of each of the plurality of headrest cushion fastening systems, respectively, to thereby attach the headrest cushion to the support plate.

It is a further aspect of the present invention to provide a massage or medical table in accordance with any previously described, wherein each of the plurality of headrest cushion fastening systems is a hook-and-loop fastening system.

It is a further aspect of the present invention to provide a massage or medical table in accordance with any previously described, wherein the table frame comprises:
a rectangular frame having four corners and comprising four frame members; and
four legs each being attached to the rectangular frame at a respective one of the four corners of the rectangular frame, and
wherein the body supporting cushion comprises:
a pad of cushion material having a top and being supported on the rectangular frame; and
a cover covering at least the top of the pad of cushion material.

It is a further aspect of the present invention to provide a massage or medical table in accordance with any previously described, wherein the table frame comprises:
a first rectangular frame having four corners and comprising four frame members;
a second rectangular frame having four corners and comprising four frame members, the first rectangular frame and the second rectangular frame being attached to each other by a hinged attachment;
four legs, a first two of the four legs each being pivotally attached to the first rectangular frame at a respective one of two of the four corners of the first rectangular frame that are distally located from the hinged attachment, a second two of the four legs each being pivotally attached to the second rectangular frame at a respective one of two of the four corners of the second rectangular frame that are distally located from the hinged attachment; and
selectively collapsible bracing provided for selectively maintaining the four legs in an extended position to support the first rectangular frame and the second rectangular frame above the floor, and
wherein the at least one body supporting cushion is a first body supporting cushion comprising:
a first pad of cushion material having a top and being supported on the first rectangular frame; and
a first cover covering at least the top of the first pad of cushion material, and
wherein the body supporting portion further comprises:
a second body supporting cushion comprising:
a second pad of cushion material having a top and being supported on the second rectangular frame; and
a second cover covering at least the top of the second pad of cushion material.

It is an aspect of the present invention to provide a headrest cushion for use with a headrest frame having a support plate for supporting the headrest cushion, the headrest cushion comprising:
a top portion adapted to support a portion of the person's head at or near the person's forehead or supraorbital ridge, a left portion adapted to support a left portion of the person's face, and a right portion adapted to support a right portion of the person's face, the left and right portions of the headrest cushion being attached at one end to opposite ends of the top portion of the headrest cushion, each of the left and right portions of the headrest cushion having a distal end located distally from the top portion of the headrest cushion, there being a gap between the distal ends of the left and right portions of the headrest cushion, and the distal ends being adapted to be positioned proximate the person's chin, the headrest cushion having a front that faces toward the person's face and a back that faces away from the person's face, each of the left portion, the top portion, and the right portion of the headrest cushion having a front and a back, the front of the headrest cushion comprising the front of the left portion, the front of the top portion, and the front of the right portion, the back of the headrest cushion comprising the back of the left portion, the back of the top portion, and the back of the right portion; and
a chin strap positioned to extend across the gap and over the left and right portions of the headrest cushion on the front of the headrest cushion proximate the distal ends of the left and right portions of the headrest cushion, the chin strap extending through a left channel and a right channel and being secured to one of the headrest frame and the headrest cushion by chin strap fastening means.

It is a further aspect of the present invention to provide a headrest cushion in accordance with any previously described, wherein the chin strap fastening means comprises:
a left fastening means and a right fastening means, wherein the left fastening means secures the chin strap to the headrest frame proximate the left headrest cushion portion, wherein the right fastening means secures the chin strap to the headrest frame proximate the right headrest cushion portion, and wherein the left fastening means and the right fastening means are adapted to allow the length of the chin strap extending between the left channel and the right channel to be adjusted.

It is a further aspect of the present invention to provide a headrest cushion in accordance with any previously described, wherein the left fastening means includes a first fastener portion and a second fastener portion, wherein the right fastening means includes a first fastener portion and a second fastener portion, wherein the first fastener portion of the left fastening means is attached to the chin strap, wherein the second fastener portion of the left fastening means is attached to the headrest frame, wherein the first fastener portion of the right fastening means is attached to the chin strap, and wherein the second fastener portion of the right fastening means is attached to the headrest frame.

It is a further aspect of the present invention to provide a headrest cushion in accordance with any previously described, wherein the left fastening means is a first hook and loop fastener system, wherein the right fastening means is a second hook and loop fastener system, wherein the first fastener portion of the left fastening means is selected from a hook portion and a loop portion of the first hook and loop fastener system, wherein the second fastener portion of the left fastening means is selected from a hook portion and a loop portion of the first hook and loop fastener system and to be complementary to the first fastener portion of the left fastening means, wherein the first fastener portion of the right fastening means is selected from a hook portion and a loop portion of the second hook and loop fastener system, wherein the second fastener portion of the right fastening means is selected from a hook portion and a loop portion of the second hook and loop fastener system and to be complementary to the first fastener portion of the right fastening means.

It is a further aspect of the present invention to provide a headrest cushion in accordance with any previously described, wherein the chin strap includes a middle portion, a left portion, and a right portion, wherein each of the middle portion, the left portion, and the right portion of the chin strap has a length, wherein the first fastener portion of the left fastening means extends along at least a portion of the length of the left portion of the chin strap such that the chin strap can be attached to the headrest frame at a user selected one of a plurality of positions along the length of the left portion of the chin strap, and wherein the first fastener portion of the right fastening means extends along at least a portion of the length of the right portion of the chin strap such that the chin strap can be attached to the headrest frame at a user selected one of a plurality of positions along the length of the right portion of the chin strap.

It is a further aspect of the present invention to provide a headrest cushion in accordance with any previously described, further comprising:
a plurality of fastening system portions provided on the back of the headrest cushion for attaching the headrest cushion to the support plate, the plurality of fastening system portions being capable of engaging a plurality of corresponding fastening system portions provided on the support plate to thereby attach the headrest cushion to the support plate.

It is a further aspect of the present invention to provide a headrest cushion in accordance with any previously described, wherein each of the plurality of fastening system portions is a portion of a hook-and-loop fastening system.

It is a further aspect of the present invention to provide a massage or medical table having a headrest and having left and right channels as previously described, wherein the headrest frame includes a support plate having a left side and a right side, wherein the left channel and the right channel are formed by a left strap slot and a right strap slot provided at the left side of the support plate and at the right side of the support plate, respectively, and wherein the chin strap fastening means comprises:
a left clip and a right clip, wherein the left clip and the right clip can be releasably secured to the chin strap to thereby prevent the chinstrap from being pulled through the left and right strap slots, wherein the chin strap includes a first portion extending between the left and right strap slots, wherein the chin strap extends through the left and right strap slots, wherein the first portion has a length, wherein the left clip can be secured to the chin strap on the other side of the left strap slot relative to the first portion to thereby prevent the chin strap from being pulled through the left strap slot in the direction of the first portion, wherein the right clip can be secured to the chin strap on the other side of the right strap slot relative to the first portion to thereby prevent the chin strap from being pulled through the right strap slot in the direction of the first portion, and wherein the length of the first portion can be adjusted by adjusting the positions of the left and right clips along the chin strap.

It is a further aspect of the present invention to provide a headrest comprising:
a headrest frame, wherein the headrest frame includes a support plate having a left side and a right side, wherein the support plate has at least one strap slot provided at one of the left side of the support plate and the right side of the support plate;
a headrest cushion comprising:
a top portion adapted to support a portion of the person's head at or near the person's forehead or supraorbital ridge, a left portion adapted to support a left portion of the person's face, and a right portion adapted to support a right portion of the person's face, the left and right portions of the headrest cushion being attached at one end to opposite ends of the top portion of the headrest cushion, each of the left and right portions of the headrest cushion having a distal end located distally from the top portion of the headrest cushion, there being a gap between the distal ends of the left and right portions of the headrest cushion, and the distal ends being adapted to be positioned proximate the person's chin, the headrest cushion having a front that faces toward the person's face and a back that faces away from the person's face, each of the left portion, the top portion, and the right portion of the headrest cushion having a front and a back, the front of the headrest cushion comprising the front of the left portion, the front of the top portion, and the front of the right portion, the back of the headrest cushion comprising the back of the left portion, the back of the top portion, and the back of the right portion, wherein the headrest cushion is supported by the support plate;
a chin strap positioned to extend across the gap and over the left and right portions of the headrest cushion on the front of the headrest cushion proximate the distal ends of the left and right portions of the headrest cushion, the chin strap extending through the at least one chin strap slot; and
at least one clip,
wherein the clip can be releasably secured to the chin strap to thereby prevent the chinstrap from being pulled through the strap slot, wherein the chin strap includes a first portion extending between left and right sides of the support plate, wherein the first portion has a length, wherein the clip can be secured to the chin strap on the other side of the strap slot relative to the first portion of the chin strap to thereby prevent the chin strap from being pulled through the strap slot in the direction of the first portion, and wherein the length of the first portion can be adjusted by adjusting the position of the clip along the chin strap.

It is a further aspect of the present invention to provide a headrest as previously described, wherein the support plate has a left strap slot and a right strap slot provided at the left side of the support plate and at the right side of the support plate, respectively, wherein the at least one clip is a left clip, and wherein the headrest further comprises:
a right clip, wherein the left clip and the right clip can be releasably secured to the chin strap to thereby prevent the chin strap from being pulled through the left and right strap slots, wherein the chin strap includes a first portion extending between the left and right strap slots, wherein the chin strap extends through the left and right strap slots, wherein the first portion has a length, wherein the left clip can be secured to the chin strap on the other side of the left strap slot relative to the first portion to thereby prevent the chin strap from being pulled through the left strap slot in the direction of the first portion, wherein the right clip can be secured to the chin strap on the other side of the right strap slot relative to the first portion to thereby prevent the chin strap from being pulled through the right strap slot in the direction of the first portion, and wherein the length of the first portion can be adjusted by adjusting the positions of the left and right clips along the chin strap.

These and other aspects of the present invention will become readily apparent upon study of the detailed description of the invention provided below and the attached drawings.

### BRIEF DESCRIPTION OF THE DRAWING FIGURES

FIG. 1 is an environmental plan view of the headrest cushion of the present invention.

FIGS. 2-3 are views of the chin strap of the present invention.

FIG. 4 is a plan view of the headrest cushion of the present invention.

FIG. 5 is a plan view of the back of the headrest cushion of the present invention.

FIGS. 6A-6B are perspective views showing the headrest frame used with the present invention.

FIGS. 7-8 are environmental views of the headrest frame of the present invention.

FIG. 9 is an environmental view of the grommets used in the present invention for mounting the headrest frame to the table.

FIGS. 10-16 are environmental views of the headrest according to the present invention.

FIG. 17 is a perspective view showing the back of the headrest cushion support plate of the present invention.

FIGS. 18-20 are views of the body supporting portion used with a treatment table in accordance with the present invention.

FIGS. 21-22 are views showing the headrest frame in accordance with an alternative embodiment of the present invention.

FIGS. 23-24 are views showing the headrest in accordance with the alternative embodiment of the present invention.

FIGS. 25-26 are views of a treatment table including a headrest in accordance with the alternative embodiment of the present invention.

FIGS. 27-31 are views of the body supporting portion of a treatment table in accordance with the alternative embodiment of the present invention.

FIGS. 32-35 are views of the body supporting portion of a treatment table in accordance with the alternative embodiment of the present invention shown in the partially folded configuration.

FIG. 36 is a fragmentary view showing the face plate extending between a pair of legs of a treatment table in accordance with the alternative embodiment of the present invention.

FIGS. 37-38 are fragmentary views showing details of the headrest in accordance with the alternative embodiment of the present invention.

### DETAILED DESCRIPTION

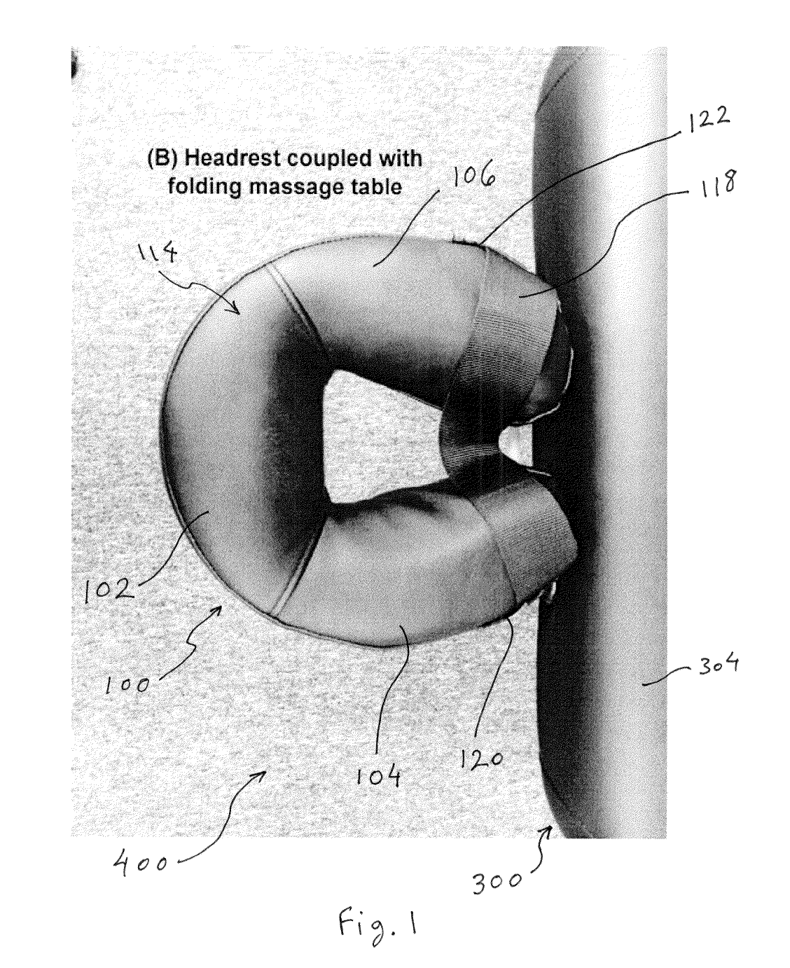

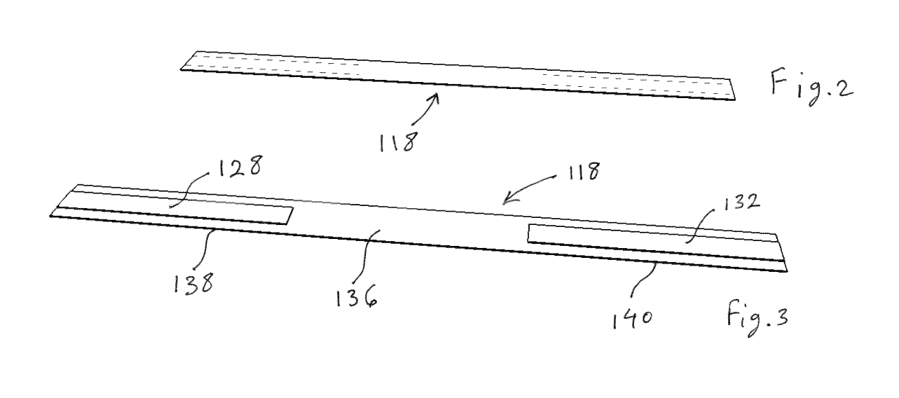

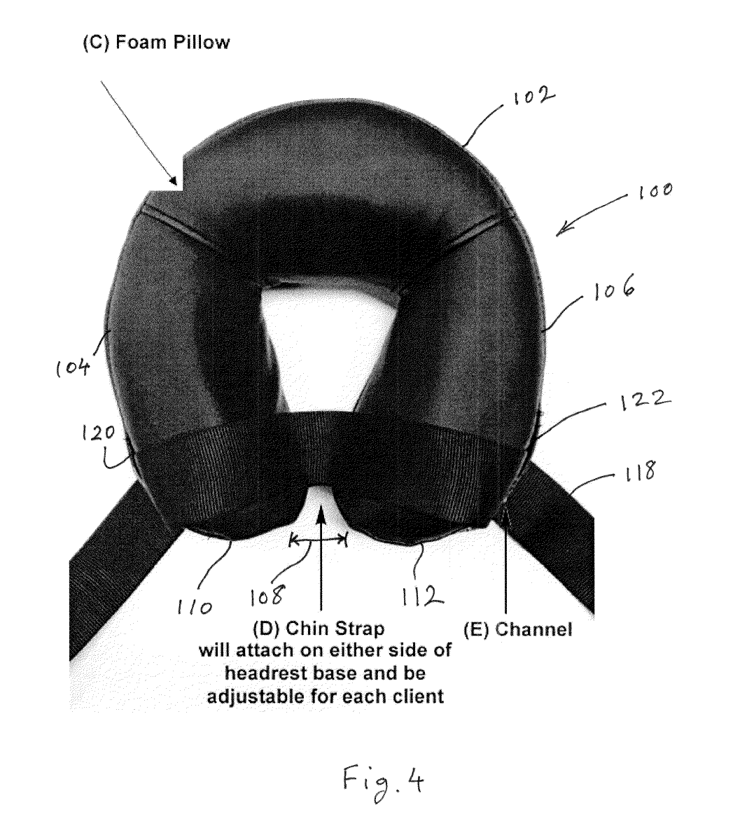

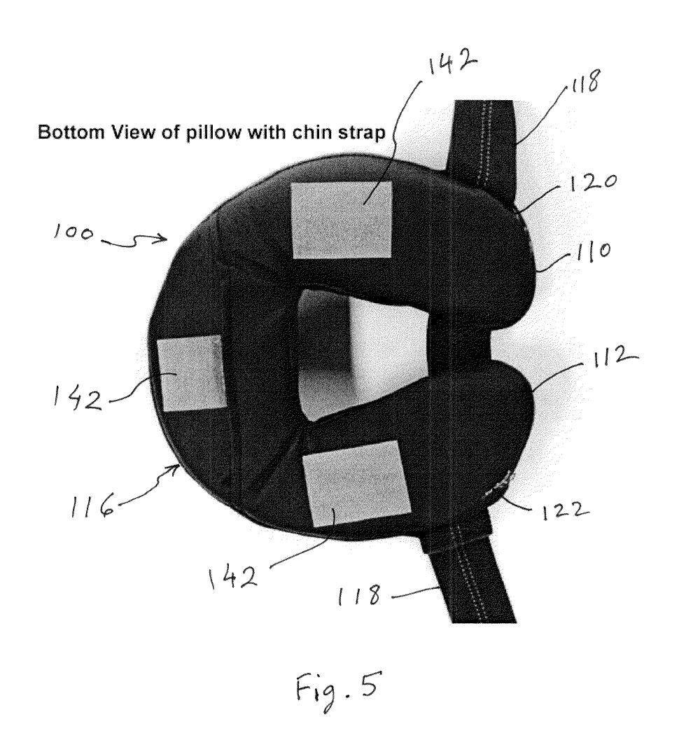

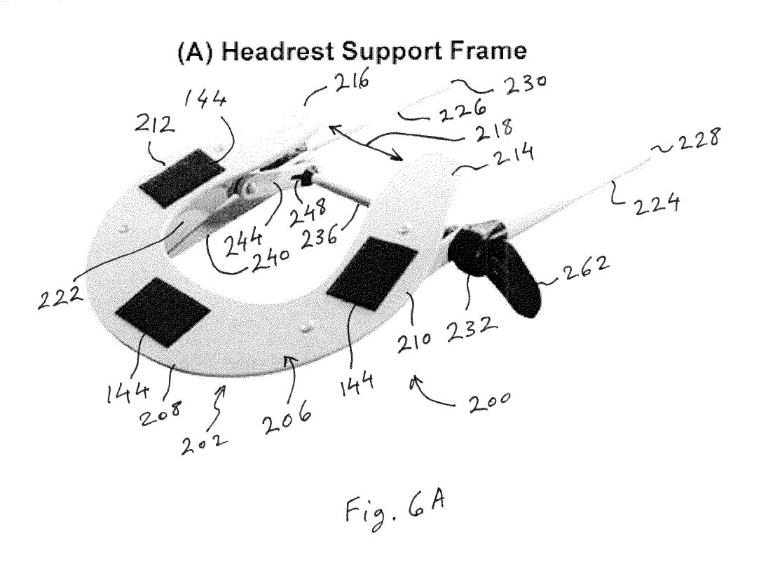

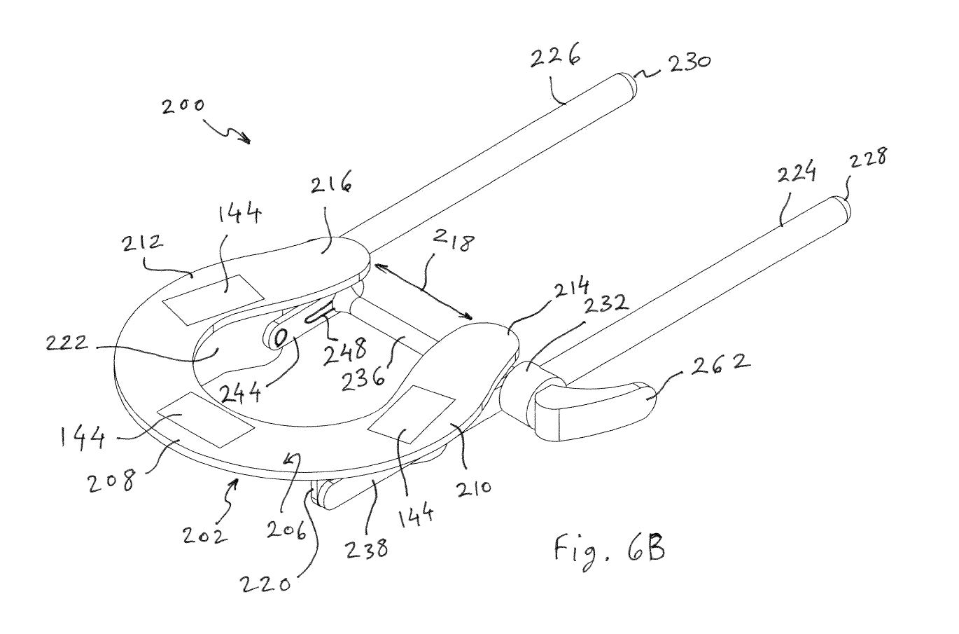

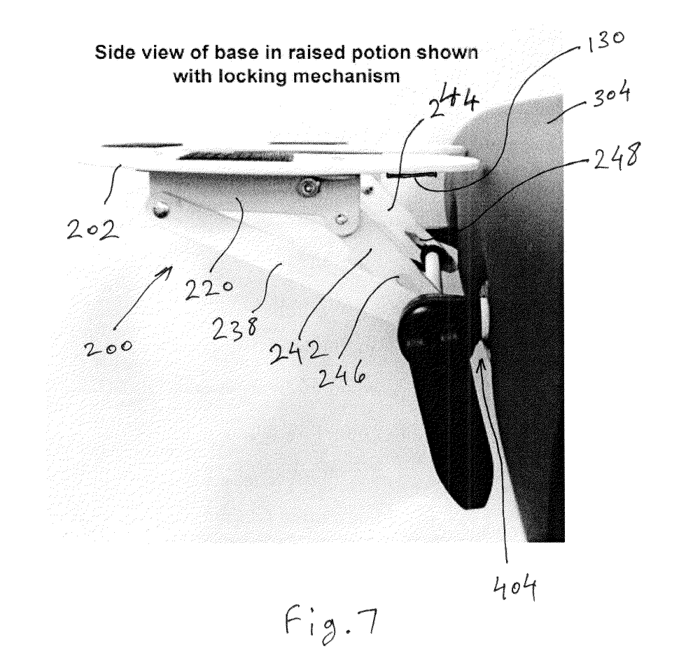

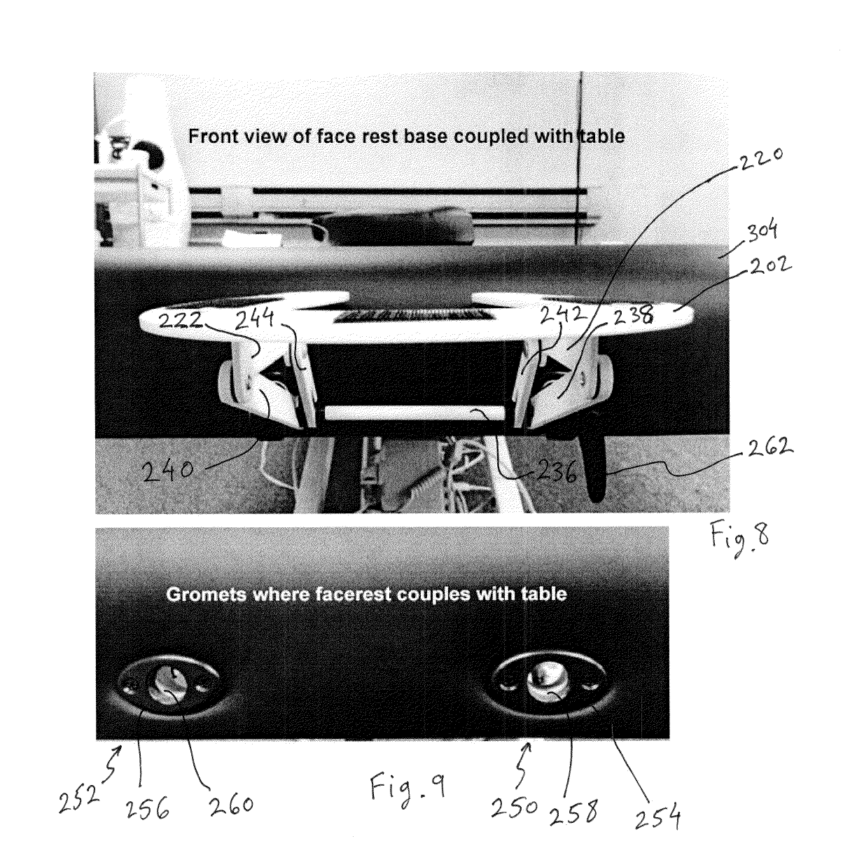

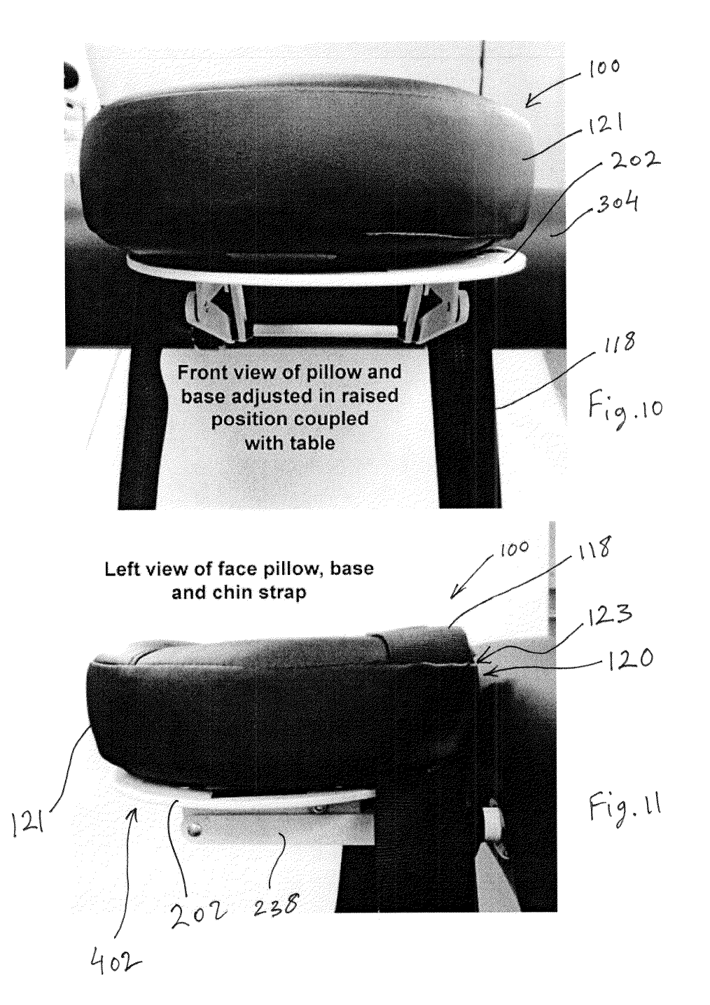

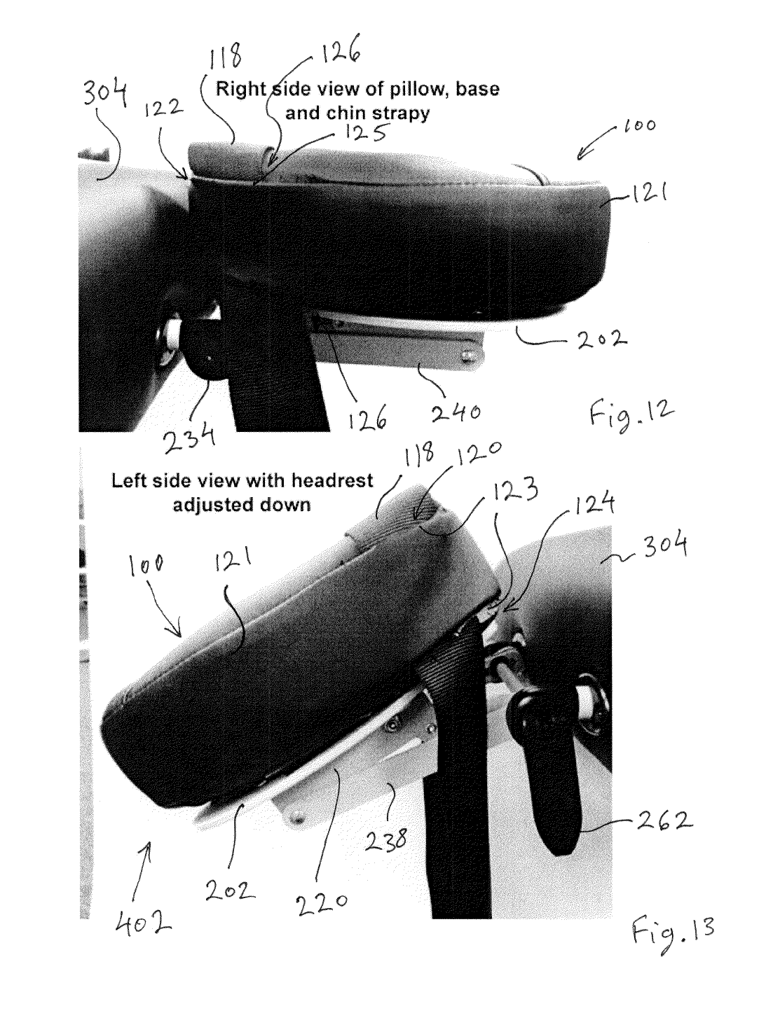

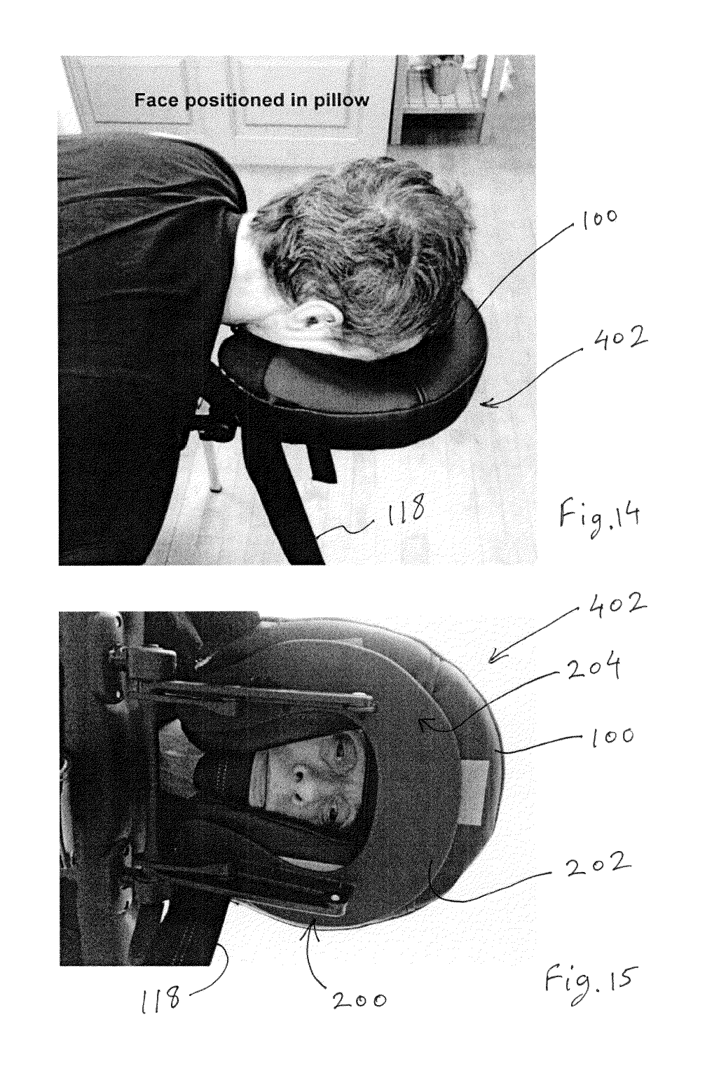

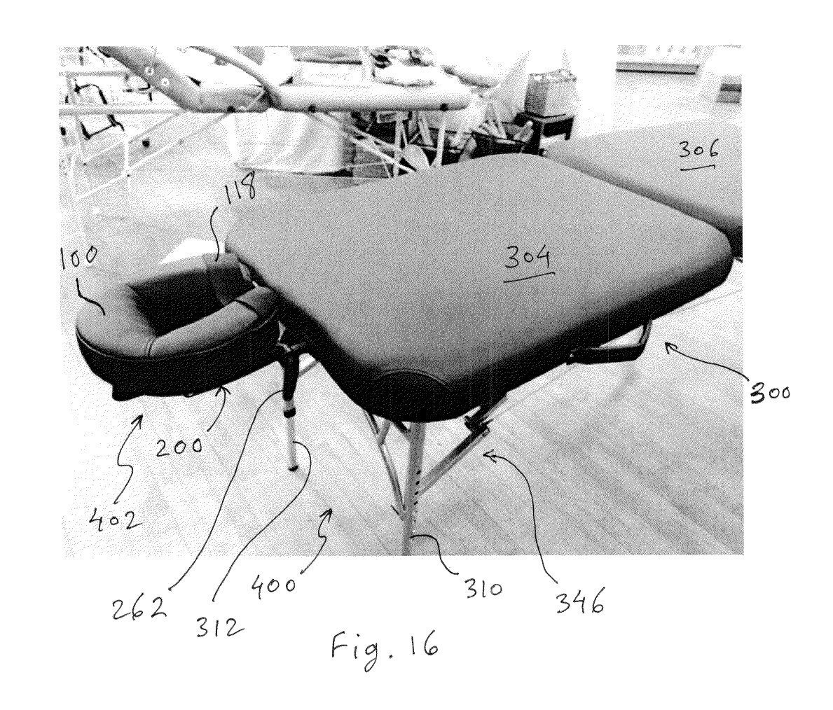

Referring to FIGS. 1-14, the present invention includes a headrest cushion 100 for use with a headrest frame 200 having a support plate 202 for supporting the headrest cushion 100. The headrest cushion includes a top portion 102 adapted to support a portion of the person's head at or near the person's forehead or supraorbital ridge, a left portion 104 adapted to support a left portion of the person's face, and a right portion 106 adapted to support a right portion of the person's face. The left and right portions 104, 106 of the headrest cushion 100 are attached at one end to opposite ends of the top portion 102 of the headrest cushion 100. Each of the left and right portions 104, 106 of the headrest cushion 100 has a distal end located distally from the top portion 102 of the headrest cushion 100. There is a gap 108 between the distal ends 110, 112 of the left and right portions 104, 106 of the headrest cushion 100. The distal ends 110, 112 are adapted to be positioned proximate the person's chin. The headrest cushion has a front 114 that faces toward the person's face and a back 116 that faces away from the person's face. Each of the left portion 104, the top portion 102, and the right portion 106 of the headrest cushion 100 has a front and a back. The front 114 of the headrest cushion 100 comprises the front of the left portion 104, the front of the top portion 102, and the front of the right portion 106, the back 116 of the headrest cushion 100 comprises the back of the left portion 104, the back of the top portion 102, and the back of the right portion 106.

The headrest cushion 100 also includes a chin strap 118 positioned to extend across the gap 108 and over the left and right portions 104, 106 of the headrest cushion 100 on the front of the headrest cushion 100 proximate the distal ends 110, 112 of the left and right portions of the headrest cushion. The chin strap 118 is secured to the headrest 402 by chin strap fastening means 124, 126. The chin strap 118 extends through a left channel 120 and a right channel 122 and is secured to one of the headrest frame 200 and the headrest cushion 100 by the chin strap fastening means 124, 126.

The chin strap fastening means includes a left fastening means 124 and a right fastening means 126. The left fastening means 124 secures the chin strap 118 to the headrest frame 200 proximate the left headrest cushion portion 104. The right fastening means 126 secures the chin strap 118 to the headrest frame 200 proximate the right headrest cushion portion 106. Alternatively, the left fastening means 124 can be configured to secure the chin strap 118 to the left headrest cushion portion 104, and the right fastening means 126 can be configured to secure the chin strap 118 to the right headrest cushion portion 106. The ends of the chin strap 118 may even be secured back onto itself after looping around the left and right portions 104, 106 of the headrest cushion 100. The left fastening means 124 and the right fastening means 126 are adapted to allow the length of the chin strap 118 extending between the left channel 120 and the right channel 122 to be adjusted.

In the illustrated embodiment, a panel 121, that forms the perimeter of the cover of the headrest cushion 100, has two pairs of openings 123, 125 that allow the chin strap 118 to pass between the panel 121 and the foam padding of the cushion 100, thus forming the left channel 120 and the right channel 122. Each pair of openings 123, 125 is located on the outer side of a respective one of the left and right portions 104, 106 of the headrest cushion 100 near the distal end of the respective left or right portion 104, 106 such that the chin strap 118 will be located near the chin of a person receiving treatment on the table 400. Panels or sections of cushion cover material may be provided in the channels 120 and 122 between the panel 121 and the foam cushion material or padding to prevent any of the padding from being exposed within the channels 120 and 122 and to encase and protect the cushion's foam padding. The chin strap 118 would then pass between the panel 121 and the sections of cushion cover material encasing and protecting the cushion's foam padding. The panel 121 may be made up of multiple panels. Alternatively, the left channel 120 and the right channel 122 can be made of flexible strips attached at either end to the outer sides or outer perimeter of the left and right portions 104, 106 of the headrest cushion 100, respectively. This arrangement would allow the chin strap 118 to pass between each of the flexible strips and the outer side of the left and right portions 104, 106 of the headrest cushion 100. The ends of each strip may be attached to the outer side of the left and right portions 104, 106 of the headrest cushion 100 by, for example, sewing. Tubular sleeves of cushion cover material may also be used to provide the channels 120 and 122. As yet other alternatives, the left channel 120 and the right channel 122 may be made of C-shaped or slotted, relatively rigid, plastic or metal structures that allow the passage of the chin strap 118 through them.

The left fastening means 124 includes a first fastener portion 128 and a second fastener portion 130. The right fastening means 126 includes a first fastener portion 132 and a second fastener portion 134. The first fastener portion 128 of the left fastening means 124 is attached to the chin strap 118. The second fastener portion 130 of the left fastening means 124 is attached to the headrest frame 200. Alternatively, the second fastener portion 130 of the left fastening means 124 may be attached to the left headrest cushion portion 104 or the chin strap 118 as previously explained. The first fastener portion 132 of the right fastening means 126 is attached to the chin strap 118, and the second fastener portion 134 of the right fastening means 126 is attached to the headrest frame 200. Alternatively, the second fastener portion 134 of the right fastening means 126 may be attached to the right headrest cushion portion 106 or the chin strap 118 as previously explained. Also, the second portion of the right and left fastening means 124, 126 may be provided inside the channels 120, 122, respectively.

In the illustrated example, the left fastening means 124 is a first hook and loop fastener system, and the right fastening means 126 is a second hook and loop fastener system. The first fastener portion 128 of the left fastening means 124 is selected from a hook portion and a loop portion of the first hook and loop fastener system, and the second fastener portion 130 of the left fastening means 124 is selected from a hook portion and a loop portion of the first hook and loop fastener system. The second fastener portion 130 of the left fastening means 124 is selected to be complementary to the first fastener portion 128 of the left fastening means 124. The first fastener portion 132 of the right fastening means 126 is selected from a hook portion and a loop portion of the second hook and loop fastener system, and the second fastener portion 134 of the right fastening means 126 is selected from a hook portion and a loop portion of the second hook and loop fastener system. The second fastener portion 134 of the right fastening means 126 is selected to be complementary to the first fastener portion 132 of the right fastening means 126.

The chin strap 118 includes a middle portion 136, a left portion 138, and a right portion 140. Each of the middle portion 136, the left portion 138, and the right portion 140 of the chin strap 118 has a length. In the illustrated embodiment, the first fastener portion 128 of the left fastening means 124 extends along at least a portion of the length of the left portion 138 of the chin strap 118 such that the chin strap 118 can be attached to the headrest frame 200 at a user selected one of a plurality of positions along the length of the left portion 138 of the chin strap 118. Also, the first fastener portion 132 of the right fastening means 126 extends along at least a portion of the length of the right portion 140 of the chin strap 118 such that the chin strap 118 can be attached to the headrest frame 200 at a user selected one of a plurality of positions along the length of the right portion 140 of the chin strap 118.

A plurality of fastening system portions 142 are provided on the back of the headrest cushion 100 for attaching the headrest cushion 100 to the support plate 202. The plurality of fastening system portions 142 are capable of engaging a plurality of corresponding fastening system portions 144 provided on the support plate 202 to thereby attach the headrest cushion 100 to the support plate 202. Each of the plurality of fastening system portions 142, 144 is a portion of a hook-and-loop fastening system.

The present invention also includes a massage or medical table 400, for providing treatment or therapy to a person. The massage table 400 uses the headrest 402 that includes the headrest frame 200 and the headrest cushion 100. The massage table 400 includes the headrest 402, the body supporting portion 300, and attachment means 404 for attaching the headrest 402 to the body supporting portion 300. In the illustrated example, the attachment means 404 includes the grommets 250, 252 and the elongated members 224, 226.

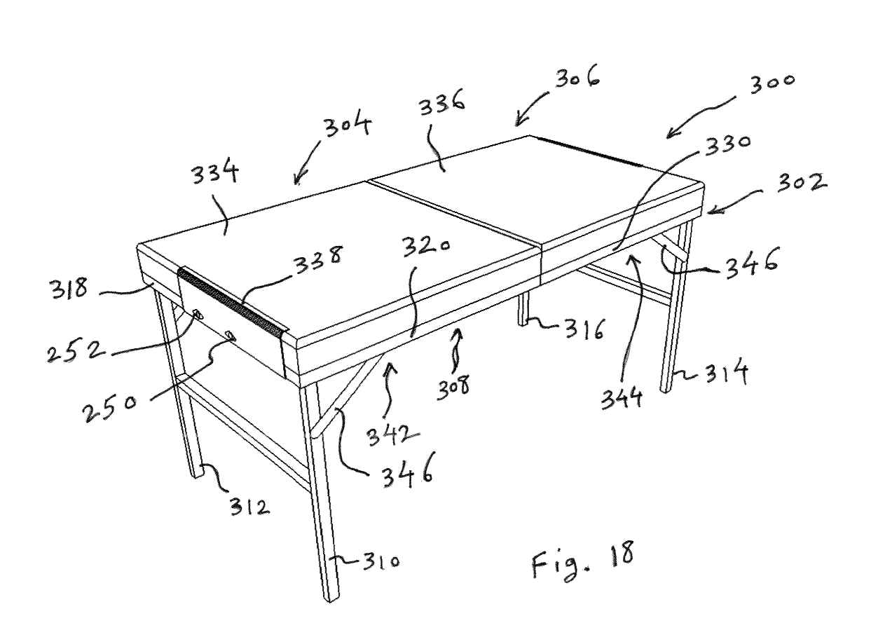

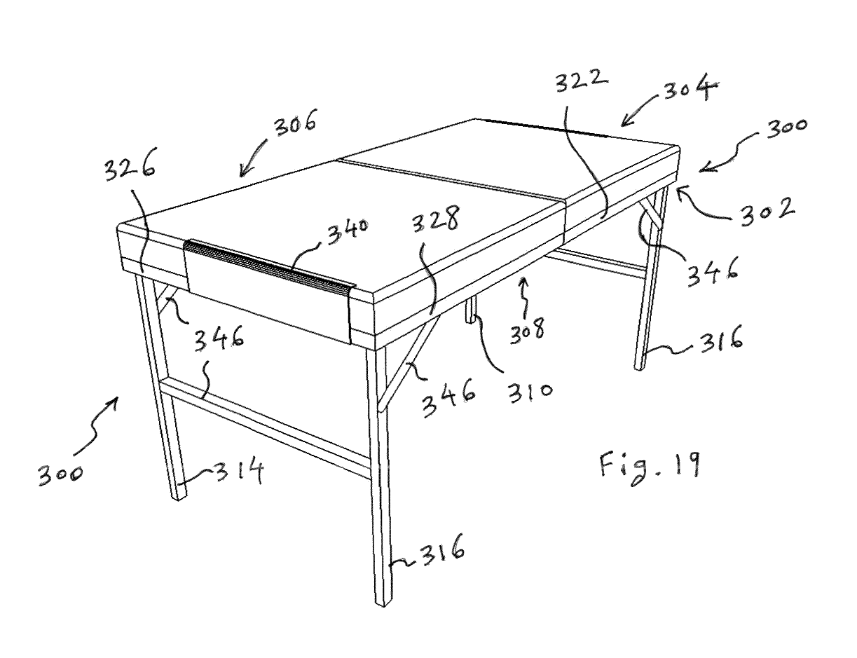

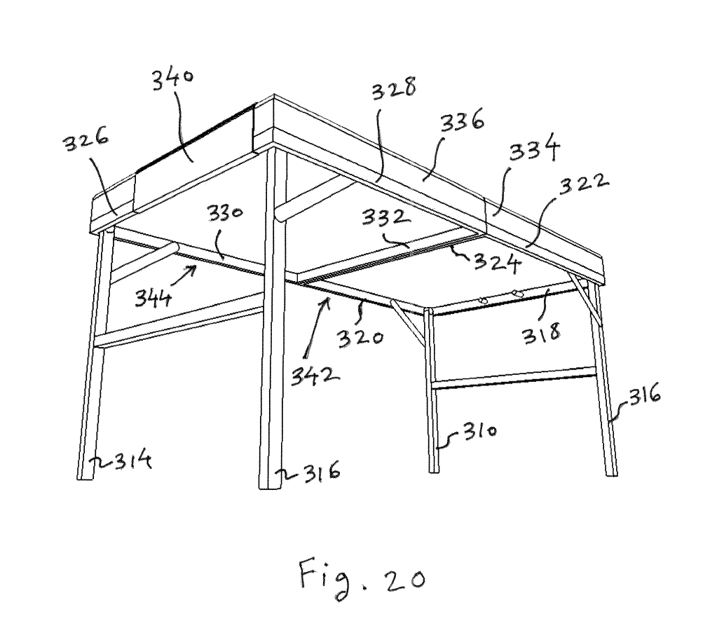

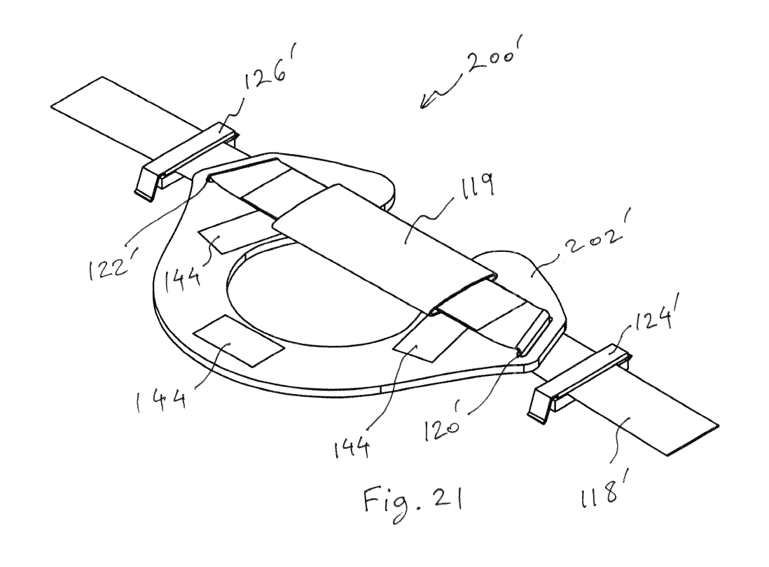

The body supporting portion 300 includes a table frame 302 at least one body supporting cushion 304, 306. The body supporting cushion 304, 306 is adapted for supporting at least a portion of a person's body other than the person's head. The table frame 302 is adapted for supporting the body supporting cushion 304, 306 at a height above a floor. The cover of the body supporting cushions 304, 306 and the headrest cushion 100 can be made of vinyl, natural leather, simulated leather, fabric, and the like. In FIGS. 18-20, the cushion covers are partially broken away to reveal the cushion material or padding.

The headrest frame 200 includes the support plate 202. The support plate 202 has a back side 204 and a front side 206. The support plate 202 supports the headrest cushion 100 and resembles the headrest cushion 100 in planform. The support plate 202 has a top portion 208, left portion 210, and a right portion 212. The left and right portions 210, 212 of the support plate 202 are attached at one end thereof to opposite ends of the top portion 208 of the support plate 202. Each of the left and right portions 210, 212 of the support plate 202 has a distal end 214, 216 located distally from the top portion 208 of the support plate 202. There is a gap 218 between the distal ends 214, 216 of the left and right portions 210, 212 of the support plate 202. The distal ends 214, 216 of the left and right portions 210, 212 of the support plate 202 is adapted to be positioned proximate the person's chin. Each of the left portion 210, the top portion 208, and the right portion 212 of the support plate 202 has a front side and a back side. The front side 206 of the support plate 202 includes the front side of the left portion 210 of the support plate, the front side of the top portion 208 of the support plate, and the front side of the right portion 212 of the support plate. The back side 204 of the support plate 202 includes the back side of the left portion 210 of the support plate, the back side of the top portion 208 of the support plate, and the back side of the right portion 212 of the support plate.

The headrest frame 200 includes first and second attachment plates 220, 222. The first and second attachment plates 220, 222 each project perpendicularly from the back side 204 of the support plate 202. The first and second attachment plates 220, 222 are parallel to each other. The first and second attachment plates 220, 222 are spaced apart from each other, and the first and second attachment plates 220, 222 are in registry with each other. The first and second attachment plates 220, 222 each have a first end and a second end.

The headrest frame 200 includes a pair of elongated members 224, 226 each having a first end 228, 230 and a second end 232, 234. Each of the pair of elongated members 224, 226 is parallel to the other. The headrest frame 200 includes an elongated shaft 236 extending between the second ends 232, 234 of the pair of elongated members 224, 226. The elongated shaft 236 has a longitudinal axis.

The headrest frame 200 includes a first pair of linking members 238, 240 each having first and second ends. The second end of each of the first pair of linking members 238, 240 is pivotally connected to the second end of a respective one of the first and second attachment plates 220, 222. The first end of each of the first pair of linking members 238, 240 is at least pivotally connected to the second end 232, 234 of a respective one of the pair of elongated members 224, 226. Each of the first pair of linking members 238, 240 is selectively pivotally movable relative to the second end 232, 234 of the respective one of the pair of elongated members 224, 226 about a pivot axis coincident with the longitudinal axis of the elongated shaft 236.

The headrest frame 200 includes a second pair of linking members 242, 244 each having first and second ends. Each of the second pair of linking members 242, 244 has an elongated slot 246, 248 extending along a portion thereof proximate its second end. The elongated shaft 236 extends through the elongated slot 246, 248 of each of the second pair of linking members 242, 244. The first end of each of the second pair of linking members 242, 244 is pivotally connected to the first end of a respective one of the first and second attachment plates 220, 222. The support plate 202 has a position and a tilt angle relative to the body supporting portion 300, and the first pair of linking members 238, 240 and the second pair of linking members 242, 244 allow for adjustment of the position and the tilt angle of the support plate 202, and in turn of the headrest cushion 100, to suit the person receiving treatment.

The body supporting portion 300, and in turn the massage table 400, further include a pair of grommets 250, 252 supported by the body supporting portion 300 at one end the body supporting portion 300. Each of the pair of grommets 250, 252 has a flange 254, 256 adapted for attachment to the body supporting portion 300, and each of the pair of grommets 250, 252 has a sleeve 258, 260 adapted for receiving a portion of a respective one of the pair of elongated members 224, 226 to thereby mount the headrest 402 to the body supporting portion 300.

The headrest frame 200, and in turn the massage or medical table 400, further includes a locking lever 262 operably linked to the elongated shaft 236 and being pivotally movable between a first position and a second position. The support plate 202 is locked in position relative to the body supporting portion 300 when the locking lever 262 is in the first position, and the support plate 202 is released for movement to adjust its position and tilt angle relative to the body supporting portion 300 when the locking lever 262 is in the second position.

The headrest 402 further includes headrest cushion fastening means for attaching the headrest cushion 100 to the support plate 202. The headrest cushion fastening means includes a plurality of headrest cushion fastening systems each having a first portion 144 for attachment to the front side of the support plate 202 and a second portion 142 for attachment to the back of the headrest cushion 100. The first portion 144 of each of the plurality of headrest cushion fastening systems engages the second portion 142 of each of the plurality of headrest cushion fastening systems, respectively, to thereby attach the headrest cushion 100 to the support plate 202. Each of the plurality of headrest cushion fastening systems is a hook-and-loop fastening system.

The table frame 302 includes a rectangular frame 308 and four legs 310, 312, 314, and 316. The rectangular frame 308 has four corners and includes at least four frame members 318, 320, 322, 324, 326, 328, 330, and 332. Each of the four legs 310, 312, 314, and 316 is attached to the rectangular frame 308 at a respective one of the four corners of the rectangular frame.

The body supporting cushion 304, 306 includes a pad of cushion material 334, 336 that has a top and is supported on the rectangular frame 308. The body supporting cushion 304, 306 also includes a cover 338, 340 covering at least the top of the pad of cushion material 334, 336.

In the illustrated embodiment, the table frame 302, and in turn the rectangular frame 308, includes a first rectangular frame 342 and a second rectangular frame 344. The first rectangular frame 342 has four corners and includes four frame members 318, 320, 322, and 324. The second rectangular frame 344 has four corners and includes four frame members 326, 328, 330, and 332. The first rectangular frame 342 and the second rectangular frame 344 are attached to each other by a hinged attachment. The first two of the four legs 310, 312, 314, and 316 are each pivotally attached to the first rectangular frame 342 at a respective one of two of the four corners of the first rectangular frame 342 that are distally located from the hinged attachment between the first and second rectangular frame members 342, 344. Another two of the four legs 310, 312, 314, and 316 are each pivotally attached to the second rectangular frame 344 at a respective one of two of the four corners of the second rectangular frame 344 that are distally located from the hinged attachment between the first and second rectangular frame members 342, 344.

Selectively collapsible bracing 346 is provided for selectively maintaining the four legs 310, 312, 314, and 316 in an extended position to support the first rectangular frame 342 and the second rectangular frame 344 above the floor. The at least one body supporting cushion is a first body supporting cushion 304 that includes a first pad of cushion material 334 having a top and being supported on the first rectangular frame 342. The first body supporting cushion 304 also includes a first cover 338 that covers at least the top of the first pad of cushion material 334. The body supporting portion 300 further includes a second body supporting cushion 306. The second body supporting cushion 306 includes a second pad of cushion material 336 having a top and being supported on the second rectangular frame 344. The second body supporting cushion 306 further includes a second cover 340 that covers at least the top of the second pad of cushion material 336. This arrangement allows the table 400 to be folded for easy transportation and storage.

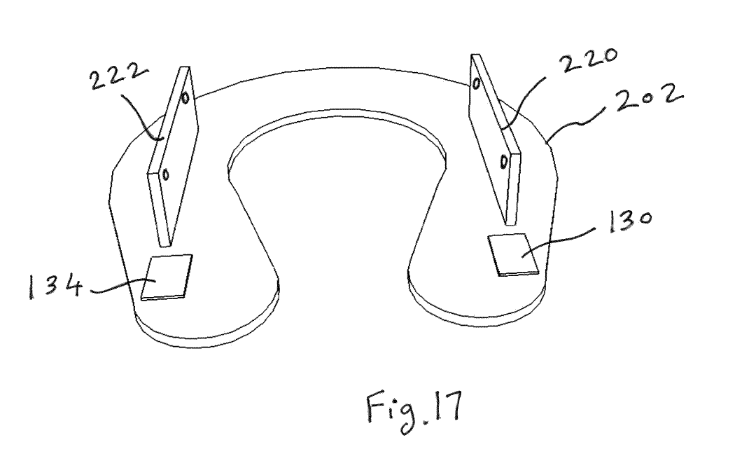

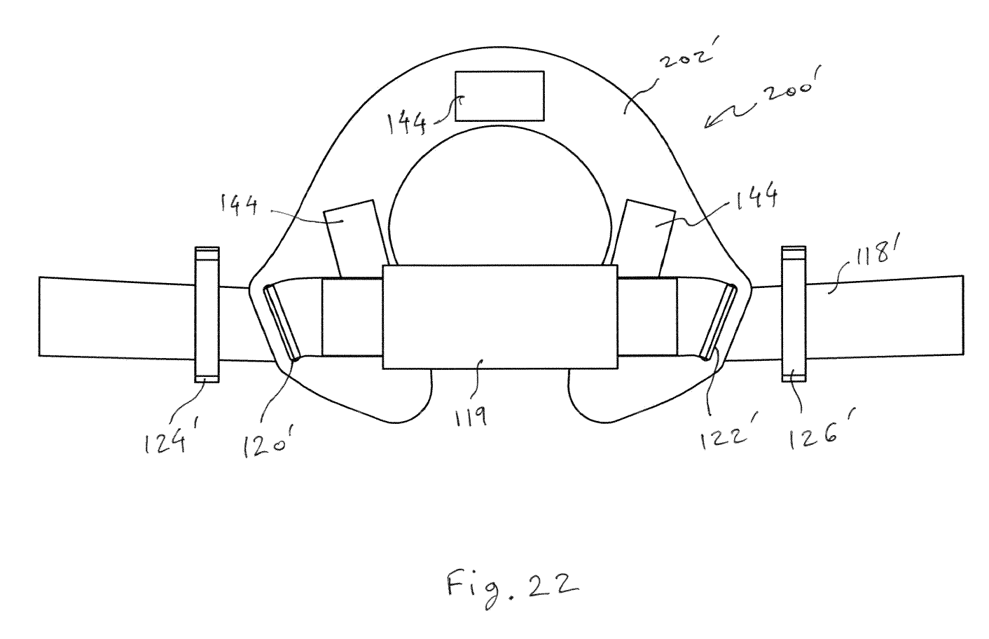

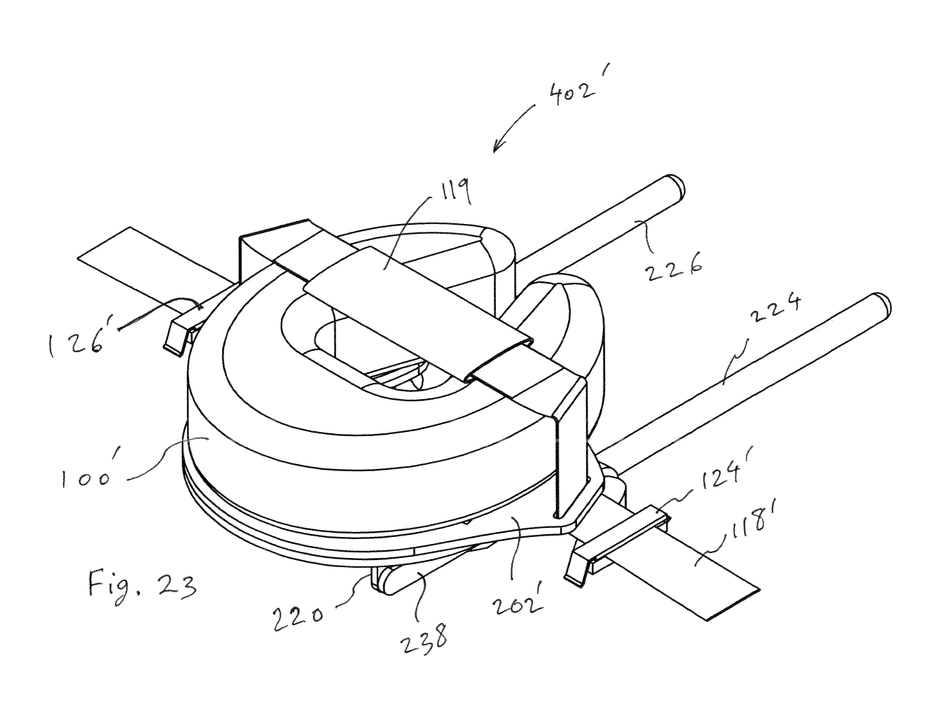

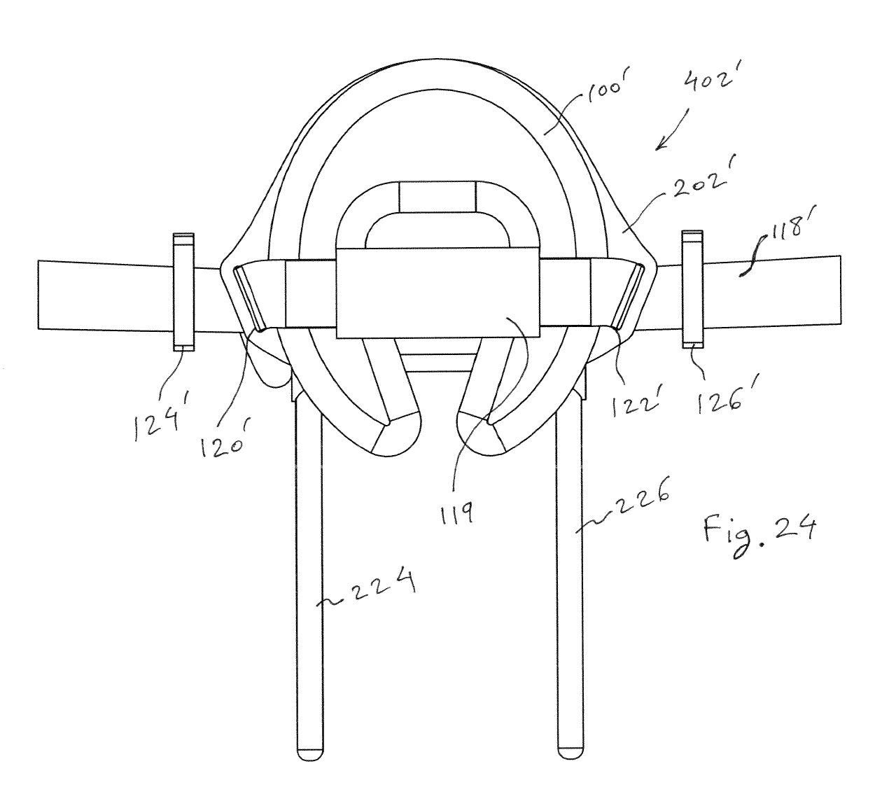

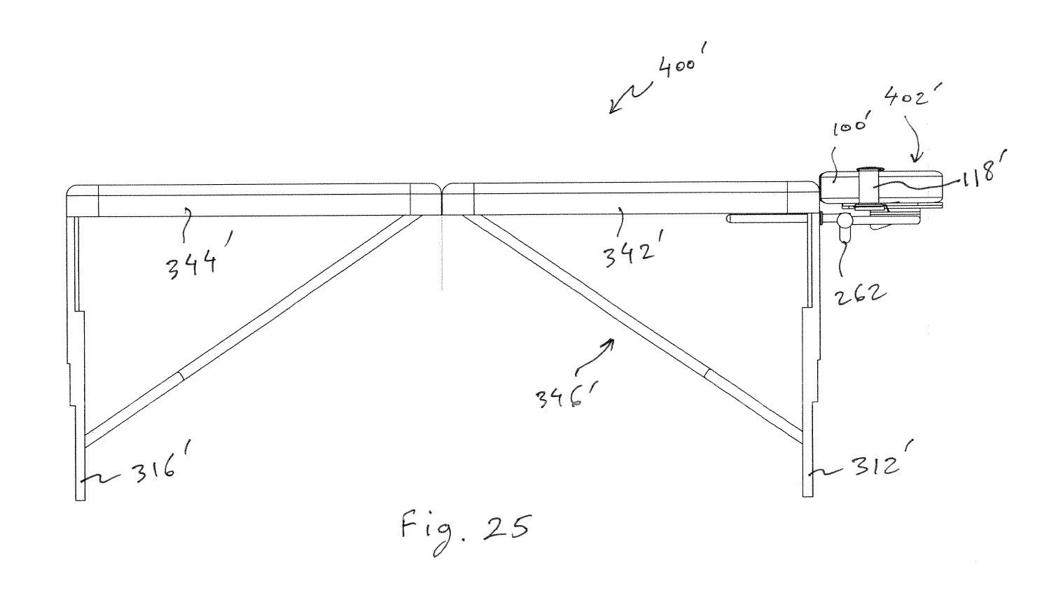

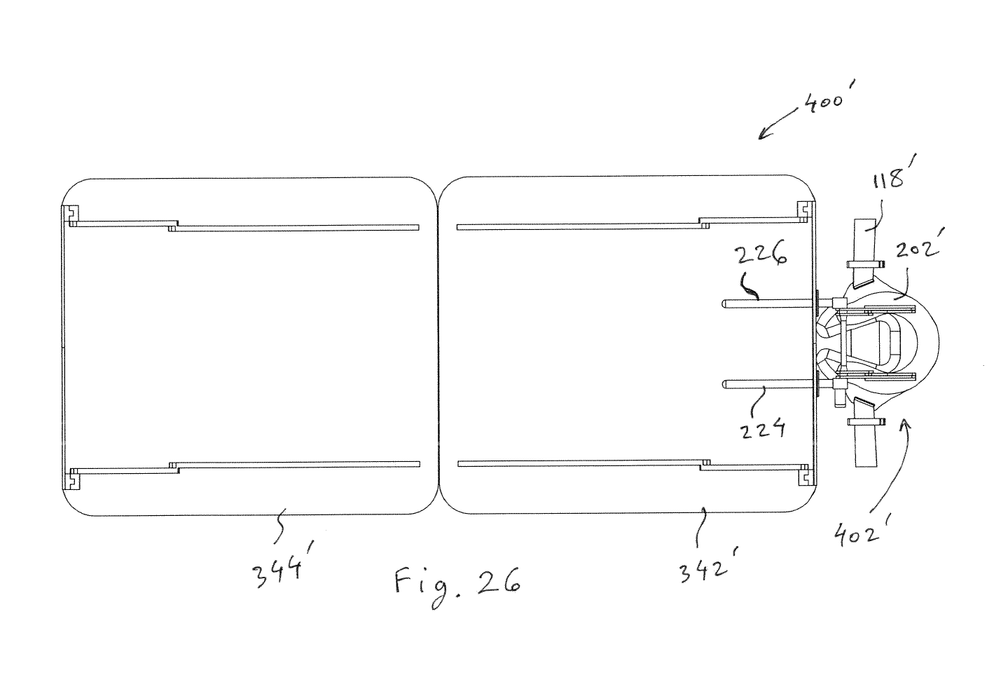

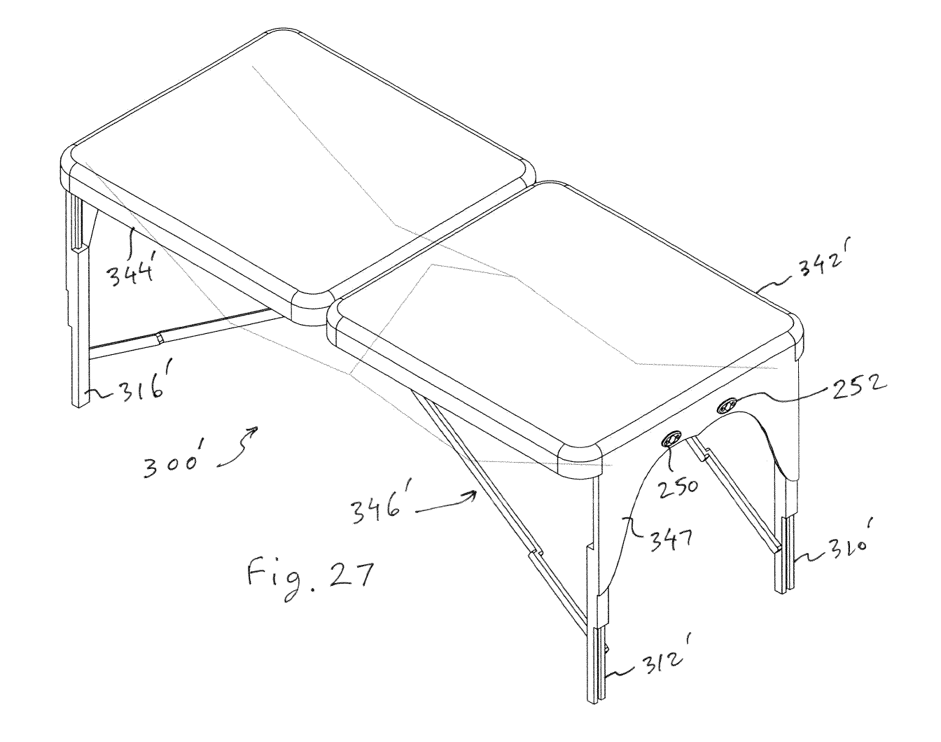

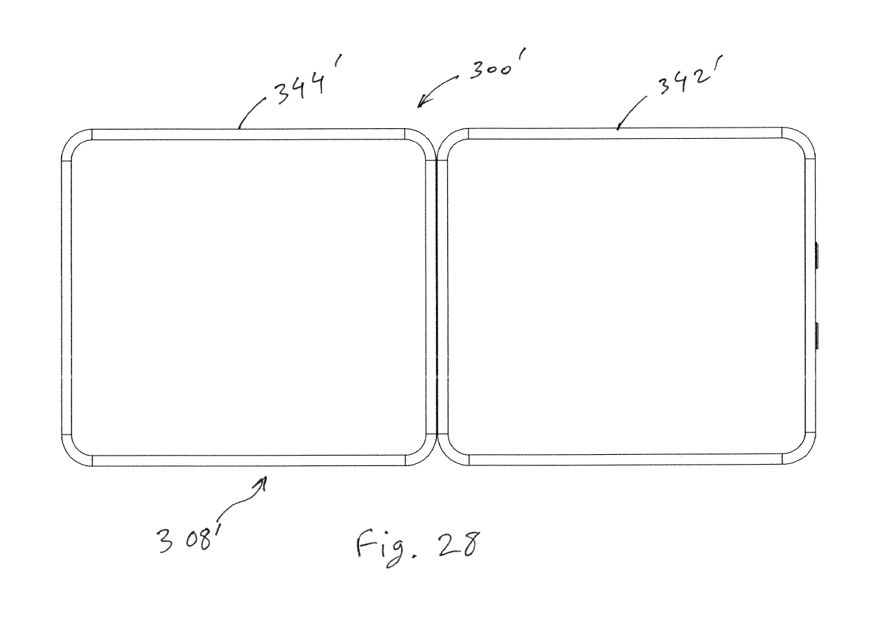

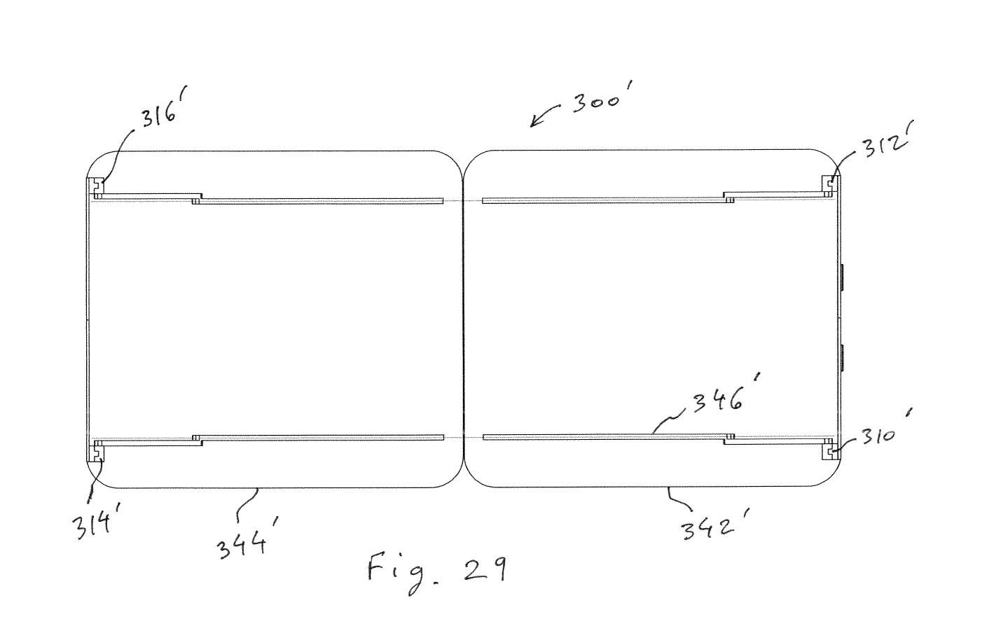

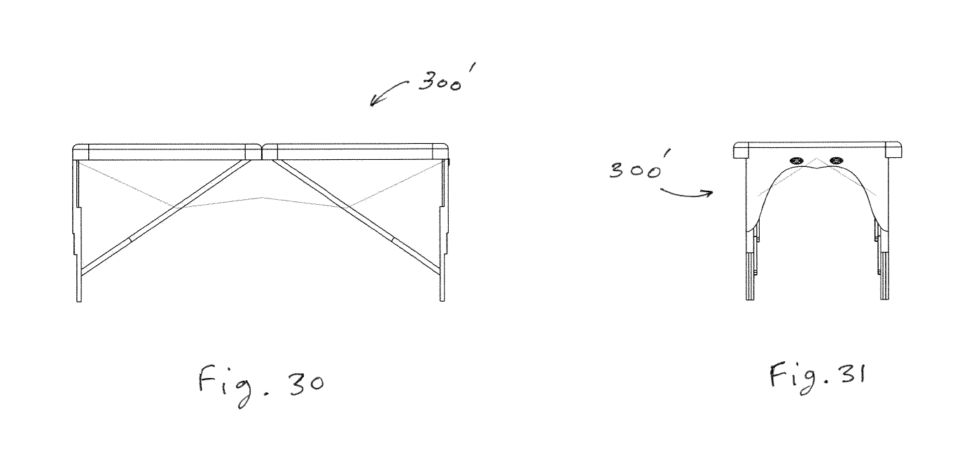

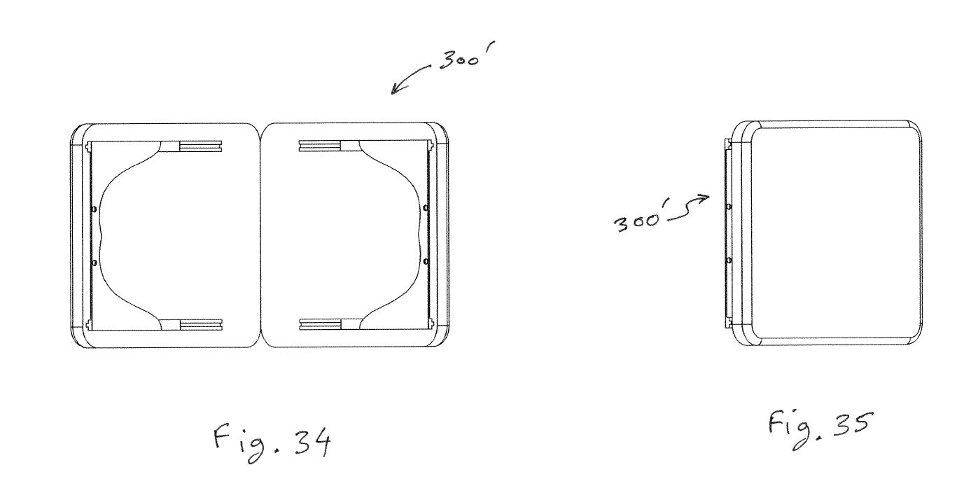

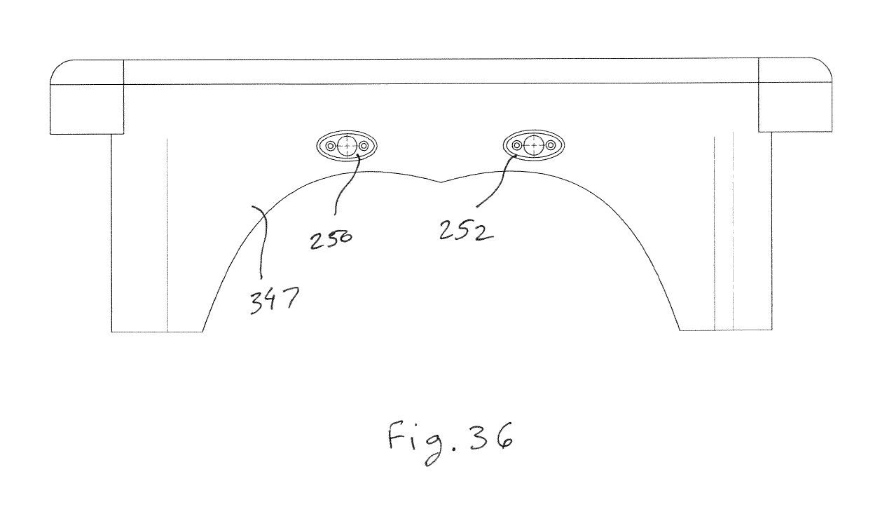

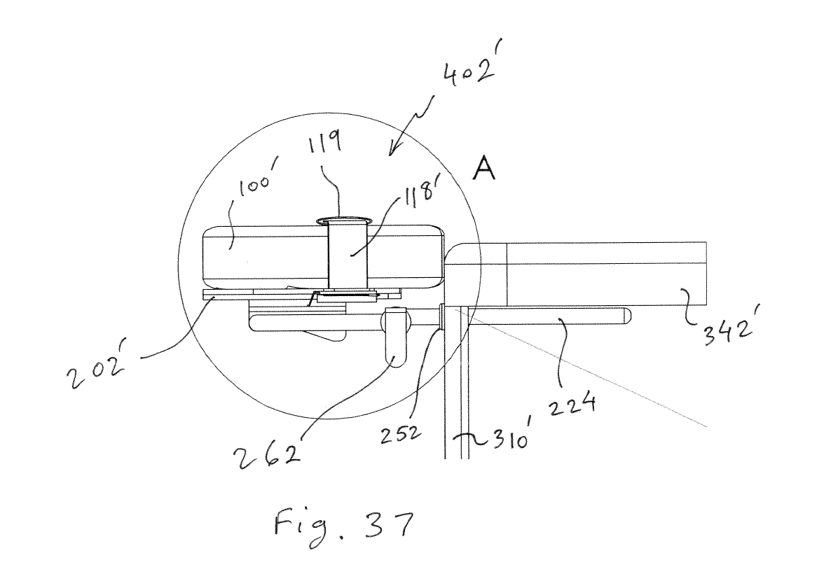

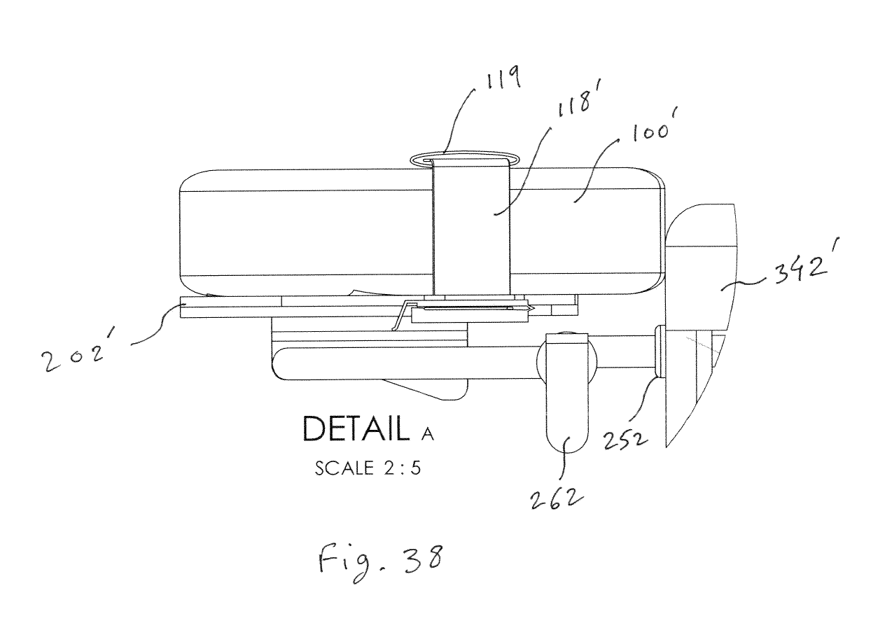

Referring to FIGS. 21-38, an alternative embodiment 400′ of the present invention can be seen. In the interest of brevity, only those aspects of the second embodiment that are significantly different from the embodiment of FIGS. 1-20 will be discussed in detail. In all other respects of significance to the invention, the remarks regarding the embodiment of FIGS. 1-20 are applicable to embodiment of FIGS. 21-38.

The treatment table 400′ includes a headrest 402′ and a body supporting portion 300′. The headrest 402′ includes a headrest frame 200′ and the headrest cushion 100′. The headrest cushion 100′ requires no provision for fastening or guiding the strap 118′; however, such features may optionally be provided. The strap 118′ requires no hook and loop fastener portion; however, such features may optionally be provided.

The headrest frame 200′ includes a support plate 202′ that has a left strap slot 120′ and a right strap slot 122′ provided at the left side of the support plate and at the right side of the support plate, respectively. The headrest 402′ also includes a left clip 124′ and a right clip 126′. In the illustrated embodiment, each of the clips 124′, 126′ has a pair of jaws that are pivotally attached at one end and can be releasably fastened together at the other, using a snap fastener, to thereby allow the strap 118′ to be clamped between the jaws such that movement of the clips along the strap is prevented when the jaws are fastened together. If the jaws are released from one another at one end then the position of the clip along the strap 118′ can be adjusted. The clips 124′, 126′ must be too large to pass through at least the corresponding one of the slots 120′, 122′. Other suitable types of clips, clamps, and chord or strap locks may also be used. The left clip 124′ and the right clip 126′ can be releasably secured to the chin strap 118′ to thereby prevent the chin strap from being pulled through the left and right strap slots. The chin strap 118′ includes a first portion extending between the left and right strap slots 120′, 122′ that supports the chin of a person receiving treatment. The chin strap 118′ extends through the left and right strap slots 120′, 122′. The first portion of the strap 118′, that would support the chin of a person receiving treatment, has a length that can be adjusted to best suit the person receiving treatment. The left clip 124′ is secured to the chin strap 118′ on the other side of the left strap slot 120′ relative to the first portion of the strap 118′ to thereby prevent the chin strap 118′ from being pulled through the left strap slot 120′ in the direction of the first portion of the chin strap 118′, and the right clip 126′ is secured to the chin strap 118′ on the other side of the right strap slot 122′ relative to the first portion of the strap 118′ to thereby prevent the chin strap 118′ from being pulled through the right strap slot 122′ in the direction of the first portion of the chin strap 118′. Thus, the clips 124′, 126′ can be used to adjustably fix the length of the first portion of the strap 118′ to suit the person receiving treatment. The length of the first portion of the strap 118′ can be adjusted by adjusting the positions of the left and right clips 124′, 126′ along the chin strap 118′.

Rather than providing clips at both ends of the strap 118′, one end of the strap 118′ can be fixed to the support plate 202′. For example, one end of the strap 118′ can be looped through one of the slots 120′, 122′ and sewn back on itself to fix that end to the support plate 202′. The other end would then be provided with a clip 124′ or 126′ to permit adjustment of the length of the first portion of the strap 118′. Alternatively, one end of the strap 118′ may be fixed to the support plate 202′ using, for example, rivets or any other type of suitable fastener.

The body supporting portion 300′ is largely the same as the body supporting 300 with some exceptions noted below. The table frame 302′ includes a rectangular frame 308′ and four legs 310′, 312′, 314′, and 316′. In all embodiments of the invention, the legs are preferably telescoping to allow for adjustment of table height. Each of the four legs 310′, 312′, 314′, and 316′ is telescoping using a tongue and groove arrangement.

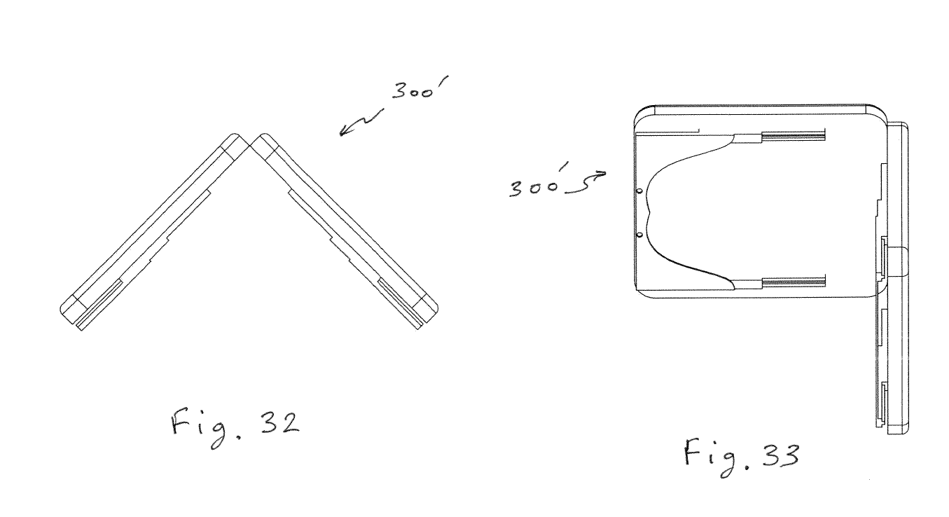

The table frame 302′, and in turn the rectangular frame 308′, includes a first rectangular frame 342′ and a second rectangular frame 344′. As before, the first rectangular frame 342′ and the second rectangular frame 344′ are hingedly attached to allow the table to be folded as shown in FIGS. 32-35.

Selectively collapsible bracing 346′ is provided for selectively maintaining the four legs 310′, 312′, 314′, and 316′ in an extended position to support the first rectangular frame 342′ and the second rectangular frame 344′ above the floor. The bracing 346′ includes a face plate 347 that supports the grommets 250, 252 for attaching the headrest 402′ to the body supporting portion 300′. This arrangement allows the table 400′ to be folded for easy transportation and storage. As before, the table 400′ has two body supporting cushions (not shown) for each of the first rectangular frame 342′ and the second rectangular frame 344′. In this embodiment, the elongated members 224, 226 are positioned below the first rectangular frame 342′. The chin strap 118, 118′ may optionally be provided with a cushioning sleeve 119 to provide added comfort to the person being treated on the treatment table.

The word “floor” is used as a generic reference for a floor, the ground, or any similar supporting surface. The present invention is not limited to the embodiments described above, but the present invention includes any and all embodiments within the scope of the appended claims and their equivalents.

1. A massage or medical table, for providing treatment or therapy to a person, comprising:
a body supporting portion comprising:
a table frame; and
at least one body supporting cushion adapted for supporting at least a portion of the person's body other than the person's head, said table frame being adapted for supporting said body supporting cushion at a height above a floor;
a headrest; and
attachment means for attaching said headrest to said body supporting portion, wherein said headrest comprises:
a headrest frame;
a headrest cushion including a top portion adapted to support a portion of the person's head at or near the person's forehead or supraorbital ridge, a left portion adapted to support a left portion of the person's face, and a right portion adapted to support a right portion of the person's face, said left and right portions of said headrest cushion being attached at one end to opposite ends of said top portion of said headrest cushion, each of said left and right portions of said headrest cushion having a distal end located distally from said top portion of said headrest cushion, there being a gap between said distal ends of said left and right portions of said headrest cushion, and said distal ends being adapted to be positioned proximate the person's chin, said headrest cushion having a front that faces toward the person's face and a back that faces away from the person's face, each of said left portion, said top portion, and said right portion of said headrest cushion having a front and a back, said front of said headrest cushion comprising said front of said left portion, said front of said top portion, and said front of said right portion, said back of said headrest cushion comprising said back of said left portion, said back of said top portion, and said back of said right portion; and
a chin strap positioned to extend across said gap and over said left and right portions of said headrest cushion on said front of said headrest cushion proximate said distal ends of said left and right portions of said headrest cushion, said chin strap extending through a left channel and a right channel and being secured to said headrest by chin strap fastening means.

2. The massage or medical table according to claim 1, wherein said chin strap fastening means comprises:
a left fastening means and a right fastening means, wherein said left fastening means secures said chin strap to said headrest frame proximate said left headrest cushion portion, wherein said right fastening means secures said chin strap to said headrest frame proximate said right headrest cushion portion, and wherein said left fastening means and said right fastening means are adapted to allow the length of said chin strap extending between said left channel and said right channel to be adjusted.

3. The massage or medical table according to claim 2, wherein said left fastening means includes a first fastener portion and a second fastener portion, wherein said right fastening means includes a first fastener portion and a second fastener portion, wherein said first fastener portion of said left fastening means is attached to said chin strap, wherein said second fastener portion of said left fastening means is attached to said headrest frame, wherein said first fastener portion of said right fastening means is attached to said chin strap, and wherein said second fastener portion of said right fastening means is attached to said headrest frame.

4. The massage or medical table according to claim 3, wherein said left fastening means is a first hook and loop fastener system, wherein said right fastening means is a second hook and loop fastener system, wherein said first fastener portion of said left fastening means is selected from a hook portion and a loop portion of said first hook and loop fastener system, wherein said second fastener portion of said left fastening means is selected from a hook portion and a loop portion of said first hook and loop fastener system and to be complementary to said first fastener portion of said left fastening means, wherein said first fastener portion of said right fastening means is selected from a hook portion and a loop portion of said second hook and loop fastener system, wherein said second fastener portion of said right fastening means is selected from a hook portion and a loop portion of said second hook and loop fastener system and to be complementary to said first fastener portion of said right fastening means.

5. The massage or medical table according to claim 4, wherein said chin strap includes a middle portion, a left portion, and a right portion, wherein each of said middle portion, said left portion, and said right portion of said chin strap has a length, wherein said first fastener portion of said left fastening means extends along at least a portion of said length of said left portion of said chin strap such that said chin strap can be attached to said headrest frame at a user selected one of a plurality of positions along said length of said left portion of said chin strap, and wherein said first fastener portion of said right fastening means extends along at least a portion of said length of said right portion of said chin strap such that said chin strap can be attached to said headrest frame at a user selected one of a plurality of positions along said length of said right portion of said chin strap.

6. The massage or medical table according to claim 5, wherein said headrest frame comprises:
a support plate having a back side and a front side, said support plate supporting said headrest cushion and resembling said headrest cushion in planform, said support plate having a top portion, left portion and a right portion, said left and right portions of said support plate being attached at one end to opposite ends of said top portion of said support plate, each of said left and right portions of said support plate having a distal end located distally from said top portion of said support plate, there being a gap between said distal ends of said left and right portions of said support plate, and said distal ends of said left and right portions of said support plate being adapted to be positioned proximate the person's chin, each of said left portion, said top portion, and said right portion of said support plate having a front side and a back side, said front side of said support plate comprising said front side of said left portion of said support plate, said front side of said top portion of said support plate, and said front side of said right portion of said support plate, said back side of said support plate comprising said back side of said left portion of said support plate, said back side of said top portion of said support plate, and said back side of said right portion of said support plate;
first and second attachment plates each projecting perpendicularly from said back side of said support plate, said first and second attachment plates being parallel to each other, said first and second attachment plates being spaced apart from each other, said first and second attachment plates being in registry with each other, said first and second attachment plates each having a first end and a second end;
a pair of elongated members each having first and second ends, each of said pair of elongated members being parallel to each other;
an elongated shaft extending between said second ends of said pair of elongated members, said elongated shaft having a longitudinal axis;
a first pair of linking members each having first and second ends, said second end of each of said first pair of linking members being pivotally connected to said second end of a respective one of said first and second attachment plates, said first end of each of said first pair of linking members being at least pivotally connected to said second end of a respective one of said pair of elongated members, each of said first pair of linking members being selectively pivotally movable relative to said second end of said respective one of said pair of elongated members about a pivot axis coincident with said longitudinal axis of said elongated shaft; and
a second pair of linking members each having first and second ends, each of said second pair of linking members having an elongated slot extending along a portion thereof proximate its second end, said elongated shaft extending through said elongated slot of each of said second pair of linking members, said first end of each of said second pair of linking members being pivotally connected to said first end of a respective one of said first and second attachment plates,
wherein said support plate has a position and a tilt angle relative to said body supporting portion and wherein said first pair of linking members and said second pair of linking members allow adjustment of said position and said tilt angle to suit the person receiving treatment.

7. The massage or medical table according to claim 6, further comprising:
a pair of grommets supported by said body supporting portion at one end thereof, each of said pair of grommets having a flange adapted for attachment to said body supporting portion, each of said pair of grommets having a sleeve adapted for receiving a portion of a respective one of said pair of elongated members to thereby mount said headrest to said body supporting portion.

8. The massage or medical table according to claim 7, further comprising:
a locking lever operably linked to said elongated shaft and being pivotally movable between a first position and a second position, wherein said support plate is locked in position relative to said body supporting portion when said locking lever is in said first position, and wherein said support plate is released for movement to adjust its position and tilt angle relative to said body supporting portion when said locking lever is in said second position.

9. The massage or medical table according to claim 6, wherein said headrest further comprises:
headrest cushion fastening means for attaching said headrest cushion to said support plate.

10. The massage or medical table according to claim 9, wherein said headrest cushion fastening means comprises:
a plurality of headrest cushion fastening systems each having a first portion for attachment to said front side of said support plate and a second portion for attachment to said back of said headrest cushion, said first portion of each of said plurality of headrest cushion fastening systems engaging said second portion of each of said plurality of headrest cushion fastening systems, respectively, to thereby attach said headrest cushion to said support plate.

11. The massage or medical table according to claim 10, wherein each of said plurality of headrest cushion fastening systems is a hook-and-loop fastening system.

12. The massage or medical table according to claim 11, wherein said table frame comprises:
a rectangular frame having four corners and comprising four frame members; and
four legs each being attached to said rectangular frame at a respective one of said four corners of said rectangular frame, and
wherein said body supporting cushion comprises:
a pad of cushion material having a top and being supported on said rectangular frame; and
a cover covering at least said top of said pad of cushion material.

13. The massage or medical table according to claim 11, wherein said table frame comprises:
a first rectangular frame having four corners and comprising four frame members;
a second rectangular frame having four corners and comprising four frame members, said first rectangular frame and said second rectangular frame being attached to each other by a hinged attachment;
four legs, a first two of said four legs each being pivotally attached to said first rectangular frame at a respective one of two of said four corners of said first rectangular frame that are distally located from said hinged attachment, a second two of said four legs each being pivotally attached to said second rectangular frame at a respective one of two of said four corners of said second rectangular frame that are distally located from said hinged attachment; and
selectively collapsible bracing provided for selectively maintaining said four legs in an extended position to support said first rectangular frame and said second rectangular frame above the floor, and
wherein said at least one body supporting cushion is a first body supporting cushion comprising:
a first pad of cushion material having a top and being supported on said first rectangular frame; and
a first cover covering at least said top of said first pad of cushion material, and
wherein said body supporting portion further comprises:
a second body supporting cushion comprising:
a second pad of cushion material having a top and being supported on said second rectangular frame; and
a second cover covering at least said top of said second pad of cushion material.

14. A headrest cushion for use with a headrest frame having a support plate for supporting the headrest cushion, the headrest cushion comprising:
a top portion adapted to support a portion of the person's head at or near the person's forehead or supraorbital ridge, a left portion adapted to support a left portion of the person's face, and a right portion adapted to support a right portion of the person's face, said left and right portions of said headrest cushion being attached at one end to opposite ends of said top portion of said headrest cushion, each of said left and right portions of said headrest cushion having a distal end located distally from said top portion of said headrest cushion, there being a gap between said distal ends of said left and right portions of said headrest cushion, and said distal ends being adapted to be positioned proximate the person's chin, said headrest cushion having a front that faces toward the person's face and a back that faces away from the person's face, each of said left portion, said top portion, and said right portion of said headrest cushion having a front and a back, said front of said headrest cushion comprising said front of said left portion, said front of said top portion, and said front of said right portion, said back of said headrest cushion comprising said back of said left portion, said back of said top portion, and said back of said right portion; and
a chin strap positioned to extend across said gap and over said left and right portions of said headrest cushion on said front of said headrest cushion proximate said distal ends of said left and right portions of said headrest cushion, said chin strap extending through a left channel and a right channel and being secured to one of the headrest frame and the headrest cushion by chin strap fastening means.

15. The headrest cushion according to claim 14, wherein said chin strap fastening means comprises:
a left fastening means and a right fastening means, wherein said left fastening means secures said chin strap to said headrest frame proximate said left headrest cushion portion, wherein said right fastening means secures said chin strap to said headrest frame proximate said right headrest cushion portion, and wherein said left fastening means and said right fastening means are adapted to allow the length of said chin strap extending between said left channel and said right channel to be adjusted.

16. The headrest cushion according to claim 15, wherein said left fastening means includes a first fastener portion and a second fastener portion, wherein said right fastening means includes a first fastener portion and a second fastener portion, wherein said first fastener portion of said left fastening means is attached to said chin strap, wherein said second fastener portion of said left fastening means is attached to said headrest frame, wherein said first fastener portion of said right fastening means is attached to said chin strap, and wherein said second fastener portion of said right fastening means is attached to said headrest frame.

17. The headrest cushion according to claim 16, wherein said left fastening means is a first hook and loop fastener system, wherein said right fastening means is a second hook and loop fastener system, wherein said first fastener portion of said left fastening means is selected from a hook portion and a loop portion of said first hook and loop fastener system, wherein said second fastener portion of said left fastening means is selected from a hook portion and a loop portion of said first hook and loop fastener system and to be complementary to said first fastener portion of said left fastening means, wherein said first fastener portion of said right fastening means is selected from a hook portion and a loop portion of said second hook and loop fastener system, wherein said second fastener portion of said right fastening means is selected from a hook portion and a loop portion of said second hook and loop fastener system and to be complementary to said first fastener portion of said right fastening means.

18. The headrest cushion according to claim 17, wherein said chin strap includes a middle portion, a left portion, and a right portion, wherein each of said middle portion, said left portion, and said right portion of said chin strap has a length, wherein said first fastener portion of said left fastening means extends along at least a portion of said length of said left portion of said chin strap such that said chin strap can be attached to said headrest frame at a user selected one of a plurality of positions along said length of said left portion of said chin strap, and wherein said first fastener portion of said right fastening means extends along at least a portion of said length of said right portion of said chin strap such that said chin strap can be attached to said headrest frame at a user selected one of a plurality of positions along said length of said right portion of said chin strap.

19. The headrest cushion according to claim 18, further comprising:
a plurality of fastening system portions provided on said back of said headrest cushion for attaching the headrest cushion to the support plate, said plurality of fastening system portions being capable of engaging a plurality of corresponding fastening system portions provided on the support plate to thereby attach the headrest cushion to the support plate.

20. The headrest cushion according to claim 19, wherein each of said plurality of fastening system portions is a portion of a hook-and-loop fastening system.

21. The massage or medical table according to claim 1, wherein said headrest frame includes a support plate having a left side and a right side, wherein said left channel and said right channel are formed by a left strap slot and a right strap slot provided at said left side of said support plate and at said right side of said support plate, respectively, and wherein said chin strap fastening means comprises:
a left clip and a right clip, wherein said left clip and said right clip can be releasably secured to said chin strap to thereby prevent said chinstrap from being pulled through said left and right strap slots, wherein said chin strap includes a first portion extending between said left and right strap slots, wherein said chin strap extends through said left and right strap slots, wherein said first portion has a length, wherein said left clip can be secured to said chin strap on the other side of said left strap slot relative to said first portion to thereby prevent said chin strap from being pulled through said left strap slot in the direction of said first portion, wherein said right clip can be secured to said chin strap on the other side of said right strap slot relative to said first portion to thereby prevent said chin strap from being pulled through said right strap slot in the direction of said first portion, and wherein said length of said first portion can be adjusted by adjusting the positions of said left and right clips along said chin strap.

22. A headrest comprising:
a headrest frame, wherein said headrest frame includes a support plate having a left side and a right side, wherein said support plate has at least one strap slot provided at one of said left side of said support plate and said right side of said support plate;
a headrest cushion comprising:
a top portion adapted to support a portion of the person's head at or near the person's forehead or supraorbital ridge, a left portion adapted to support a left portion of the person's face, and a right portion adapted to support a right portion of the person's face, said left and right portions of said headrest cushion being attached at one end to opposite ends of said top portion of said headrest cushion, each of said left and right portions of said headrest cushion having a distal end located distally from said top portion of said headrest cushion, there being a gap between said distal ends of said left and right portions of said headrest cushion, and said distal ends being adapted to be positioned proximate the person's chin, said headrest cushion having a front that faces toward the person's face and a back that faces away from the person's face, each of said left portion, said top portion, and said right portion of said headrest cushion having a front and a back, said front of said headrest cushion comprising said front of said left portion, said front of said top portion, and said front of said right portion, said back of said headrest cushion comprising said back of said left portion, said back of said top portion, and said back of said right portion, wherein said headrest cushion is supported by said support plate;
a chin strap positioned to extend across said gap and over said left and right portions of said headrest cushion on said front of said headrest cushion proximate said distal ends of said left and right portions of said headrest cushion, said chin strap extending through said at least one chin strap slot; and
at least one clip,
wherein said clip can be releasably secured to said chin strap to thereby prevent said chinstrap from being pulled through said strap slot, wherein said chin strap includes a first portion extending between left and right sides of said support plate, wherein said first portion has a length, wherein said clip can be secured to said chin strap on the other side of said strap slot relative to said first portion of said chin strap to thereby prevent said chin strap from being pulled through said strap slot in the direction of said first portion, and wherein said length of said first portion can be adjusted by adjusting the position of said clip along said chin strap.

23. The headrest according to claim 22, wherein said support plate has a left strap slot and a right strap slot provided at said left side of said support plate and at said right side of said support plate, respectively, wherein said at least one clip is a left clip, and wherein the headrest further comprises:
a right clip, wherein said left clip and said right clip can be releasably secured to said chin strap to thereby prevent said chin strap from being pulled through said left and right strap slots, wherein said chin strap includes a first portion extending between said left and right strap slots, wherein said chin strap extends through said left and right strap slots, wherein said first portion has a length, wherein said left clip can be secured to said chin strap on the other side of said left strap slot relative to said first portion to thereby prevent said chin strap from being pulled through said left strap slot in the direction of said first portion, wherein said right clip can be secured to said chin strap on the other side of said right strap slot relative to said first portion to thereby prevent said chin strap from being pulled through said right strap slot in the direction of said first portion, and wherein said length of said first portion can be adjusted by adjusting the positions of said left and right clips along said chin strap.
